(19) United States
(12) Patent Application Publication
(10) Pub. No.: US 2024/0104948 A1
(43) Pub. Date: Mar. 28, 2024

(54) TUMOR IMMUNOPHENOTYPING BASED ON SPATIAL DISTRIBUTION ANALYSIS

(71) Applicant: Genentech, Inc., South San Francisco, CA (US)

(72) Inventors: Jeffrey Ryan EASTHAM, Pacifica, CA (US); Hartmut Koeppen, San Mateo, CA (US); Xiao Li, Foster City, CA (US); Darya Yuryevna Orlova, Los Altos, CA (US)

(21) Appl. No.: 18/516,417

(22) Filed: Nov. 21, 2023

Related U.S. Application Data
(63) Continuation of application No. PCT/US22/31220, filed on May 26, 2022.
(60) Provisional application No. 63/194,009, filed on May 27, 2021.
(60) Provisional application No. 63/279,946, filed on Nov. 16, 2021.
(60) Provisional application No. 63/308,491, filed on Feb. 9, 2022.

(51) Int. Cl. G06V 20/69; G06T 7/00; G06T 7/11; G06V 10/25; G06V 10/26; G06V 10/77; G06V 10/82

(52) U.S. Cl. CPC G06V 20/698; G06T 7/0012; G06T 7/11; G06V 10/25; G06V 10/267; G06V 10/77; G06V 10/82; G06V 20/695; G06T 2207/10056; G06T 2207/20021; G06T 2207/20081; G06T 2207/30024; G06T 2207/30096; G06V 2201/03

(57) ABSTRACT

Systems and methods relate to processing digital pathology images. More specifically, techniques include accessing a digital pathology image that depicts a section of a biological sample, wherein the digital pathology image comprises regions displaying reactivity to a plurality of stains. For each of a plurality of tiles of the digital pathology image, a local-density measurement is calculated for each of a plurality of biological object types. One or more spatial-distribution metrics may be generated for the biological object types based at least in part on the calculated local-density measurements. A tumor immunophenotype may then be generated for the digital pathology image based at least in part on the local-density measurements or the one or more spatial-distribution metrics.

### CROSS-REFERENCE TO RELATED APPLICATIONS

This application claims the benefit of and priority to U.S. Provisional Application No. 63/194,009, entitled “Automatic Tumor Immunophenotyping Classification” and filed on May 27, 2021; U.S. Provisional Application No. 63/279,946, entitled “Tumor Immunophenotyping Based On Spatial-Distribution Analysis” and filed on Nov. 16, 2021; and U.S. Provisional Application No. 63/308,491, entitled “Tumor Immunophenotyping Based On Spatial-Distribution Analysis” and filed on Feb. 9, 2022, hereby incorporated by reference in their entireties for all purposes.

### FIELD

This application generally relates to image processing of digital pathology images to generate outputs characterizing spatial information of particular types of objects in the images.

### BACKGROUND

Image analysis includes processing individual images to generate image-level results. For example, a result may be a binary result corresponding to an assessment as to whether the image includes a particular type of object or a categorization of the image as including one or more of a set of types of objects. As another example, a result may include an image-level count of a number of objects of a particular type detected within an image or a density of the distribution of the objects of the particular type. In the context of digital pathology, a result may include a count of cells of a particular type or a display a particular indication detected within an image of a sample, a ratio of a count of one type of cell relative to a count of another type of cell across the entire image, and/or a density of a particular type of cell in particular regions of the image.

This image-level approach can be convenient, as it can facilitate metadata storage and can be easily understood in terms of how the result was generated. However, this image-level approach may strip detail from the image, which may impede detecting details of a depicted circumstance and/or environment. This simplification may be particularly impactful in the digital pathology context, as the current or potential future activity of particular types of cells may heavily depend on a microenvironment.

Therefore, it would be advantageous to develop techniques to process digital pathology images to generate an output reflective of density and spatial distribution of depicted biological objects, such as different types of cells.

### SUMMARY

With the success of immuno-oncology therapeutics, analyses of immune infiltrates in human tumors have shifted from a focus on prognostic effects towards the identification of predictive factors. The predictive or prognostic power of density and spatial distribution of tumor-infiltrating lymphocytes (TILs) is empirically proven. Yet, there is still a lack of a broad adoption of this biomarker in clinical decision-making. Evaluation of the pattern and density of immune infiltrates is, in most cases, based on visual inspection of a stained tissue section by a pathologist. This form of manual analysis is labor-intensive, subjective, error-prone and associated with poor inter- and intra-observer concordance. Semi- or fully-automated methods could serve as a potential solution. These automated solutions may inherit the lack of standardization observed in manual methods, since they aim to mimic how pathologists assess immune infiltrates. This disclosure describes an automated approach that reduces the effect of the lack of standardization and facilitates the widespread use of spatial distribution of TILs as a predictive or prognostic biomarker by using a set of derived spatial features, described herein.

In some embodiments, a computer-implemented method is provided that includes a digital pathology image processing system accessing a digital pathology image that depicts a section of a biological sample collected from a subject having a given medical condition. The digital pathology image includes regions displaying a reaction to two or more stains. The digital pathology image processing system identifies detects, one or more tumor-associated regions in the digital pathology image. The digital pathology image processing system segments subdivides the digital pathology image into a plurality of tiles. The digital pathology image processing system calculates a local density measurement of each of plurality of biological object types for each tile of the plurality of tiles. The digital pathology image processing system generates one or more spatial-distribution metrics for the biological object types in the digital pathology image based at least in part on the local density measurement calculated for each tile of the plurality of tiles of the digital pathology image. The digital pathology image processing system classifies the biological sample depicted in the digital pathology image with a particular immunophenotype based at least in part on the local density metric and the one or more spatial-distribution metrics. Classifying the biological sample depicted in the digital pathology image with a particular immunophenotype includes projecting a representation of the digital pathology image into a feature space with axes based on the one or more spatial-distribution metrics and classifying the biological sample depicted in the digital pathology image based on a position of the digital pathology image within the feature space. The classification of the biological sample depicted in the digital pathology image is further based on a proximity of the position of the digital pathology image within the feature space to a position of one or more other digital pathology image representations with assigned immunophenotype classifications. The local density measurement of each of the plurality of biological object types for each tile of the plurality of tiles includes a representation of an absolute or relative quantity of biological object depictions of a first type of the biological object types identified as being located within the tile and an absolute or relative quantity of biological object depictions of a second type of the biological object types identified as being located within the tile.

Each of the plurality of biological object types may be reactive to one of the two or more stains. Calculating the local density measurement of each of the plurality of biological object types for each tile includes, for each tile, segmenting the tile into a plurality of regions according to reactivity to the two or more stains, classifying the regions of the tile by reactivity of the biological sample to each of the two or more stains, and calculating the local density measurement of each of the plurality of biological object types for the tile based on the number of regions of the tile classified with each of the two or more stains. The regions of the tile are pixels of the digital pathology image located within the tile. The regions of the tile may be classified based on a dominant color of the region, the color being based on the reaction of each of the plurality of biological object types to one of the two or more stains. The plurality of biological object types may include cytokeratin and cytotoxic structures.

The one or more tumor-associated regions in the digital pathology image may be identified by a machine-learned model trained to identify tumor-associated regions within a digital pathology image. Identifying the one or more tumor-associated regions in the digital pathology image includes providing a user interface for display including the digital pathology image and one or more interactive elements and receiving a selection of the one or more tumor-associated regions through interaction with the one or more interactive elements. The one or more spatial-distribution metrics characterize a degree to which at least part of the first set of biological object depictions are depicted as being interspersed with at least part of the second set of biological object depictions. The one or more spatial-distribution metrics include a Jaccard index, a Sørensen index, a Bhattacharyya coefficient, a Moran's index, a Geary's contiguity ratio, a Morisita-Horn index, a Colocation Quotient, or a metric defined based on a hotspot/coldspot analysis. The digital pathology image processing system generates, based at least in part on the immunophenotype classification of the biological sample depicted in the digital pathology image and the one or more spatial-distribution metrics, a result that corresponds to an assessment of the medical condition of the subject, including a prognosis for outcomes of the medical condition. The digital pathology image processing system generates a display including an indication of the assessment of the medical condition of the subject and prognosis. Generating the result includes processing the immunophenotype classification and the one or more spatial-distribution metrics using a trained machine-learned model, the trained machine-learned model having been trained using a set of training elements, each of the set of training elements corresponding to another subject having a similar medical condition and for which an outcome of the medical condition is known. The digital pathology image processing system generates, based at least in part on the spatial-distribution metric, a result that corresponds to a prediction regarding a degree to which a given treatment that modulates immunological response will effectively treat the given medical condition of the subject. The digital pathology image processing system determines that the subject is eligible for a clinical trial based on the result. The digital pathology image processing system generates a display including an indication that the subject is eligible for the clinical trial.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed can be resorted to by those skilled in the art, and that such modifications and variations are considered to be within the scope of this invention as defined by the appended claims.

### BRIEF DESCRIPTION OF THE DRAWINGS

FIG. 1 shows an interaction system for generating and processing digital pathology images.

FIG. 2 shows an illustrative system for processing object-depiction data to generate spatial-distribution metrics.

FIG. 3 illustrates a process for providing health-related assessments based on image processing of digital pathology images.

FIGS. 4A-4F illustrate example digital pathology images showing various immunophenotype classifications.

FIGS. 5A-5B illustrate an example of pixel-based segmentation of digital pathology images.

FIG. 6 illustrates an example of tile-based local-density measurement calculation.

FIG. 7 illustrates an example annotated digital pathology image.

FIGS. 8A-8B illustrate example heatmaps of the density of a particular biological object type.

FIG. 9 illustrates a plot of biological object density bins by immunophenotype.

FIGS. 10A-10B illustrate a process for processing images using a lattice-based spatial-areal analysis framework.

FIGS. 11A-11D illustrate a process for classifying samples using immunophenotype.

FIG. 12A illustrates a process for assigning a predicted outcome label to each subject in a study cohort using a nested Monte Carlo Cross Validation modeling strategy.

FIGS. 12B and 12C illustrate example overall survival plots of classified immunophenotypes for different treatments.

FIGS. 12D and 12E illustrate example progression-free survival plots of classified immunophenotypes for different treatments.

FIG. 13 illustrates an example computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Digital images are increasingly used in the medical context to facilitate clinical assessments such as diagnoses, prognoses, treatment selections, and treatment evaluations, among a variety of other uses. In the field of digital pathology, processing of digital pathology images may be performed to estimate whether a given image includes depictions of a particular type or class of biological object. For example, a section of a tissue sample may be stained such that depictions of biological objects of a particular type (e.g., a particular type of cell, a particular type of cell organelle or blood vessels) preferentially absorb the stain and are thus depicted with a higher intensity of a particular color. By way of example and not limitation, two different immunohistochemical (IHC) stains may be applied to help identify different types of cells: a pan-cytokeratin (“PanCK”) stain may highlight cytokeratin-positive (CK+) regions (e.g., regions depicting tumor cells reactive to the PanCK stain), and a CD8 stain may highlight CD8+ regions depicting T cells (a.k.a. T lymphocytes) that express the CD8 co-receptor. The tissue sample may be imaged according to techniques disclosed herein. The digital pathology image may then be processed to detect biological object depictions. Detections of biological object depictions may be based on biological objects meeting certain criteria under analysis corresponding to the stain profile, such as having a continuity of high-intensity pixels of at least a defined amount, a size within a defined range, a shape of a defined type, etc. In particular, one or more sections, also referred to as “tiles,” of the image may be categorized based on the analysis of the digital pathology image. A clinical assessment, categorization of the underlying sample corresponding to the digital pathology image, or recommendation may made based on the image analysis.

Tumors, and particularly solid tumors, may be categorized according to the density and spatial distribution of certain immune cell components. In certain embodiments, categorization of a tumor and/or tumor sample may be based on the presence and specific location of CD8+ T cells within the tumor bed, as CD8+ T cells are known to kill cancer cells and other infected or damaged cells. In particular, evaluations may be based on the interactions between CD8+ T cells and CK+ tumor cells, as cytokeratins are known markers of epithelial cancer cells. As explained in detail herein, samples and tumors may be categorized according to the degree of infiltration of CD8+ T cells into CK+ tumor cells and the density of the CD8+ T cells therein.

With the advance of imaging technology, digital imaging of tumor tissue slides is becoming a routine clinical procedure for managing many types of conditions. Digital pathology images may capture biological objects in high resolution. It may be advantageous to characterize a degree of spatial heterogeneity and/or density of biological objects captured in the digital pathology image and an extent to which the objects of the given type are spatially aggregated and/or distributed relative to each other and/or relative to objects of different types, such as in the context of the evaluation of infiltration of CD8+ T cells into tumor beds. The locations and relationships of biological object depictions in a digital pathology image may correlate with the locations and relationship of the corresponding biological objects in the tissue samples of a subject. Objectively characterizing density and relationships of biological object depictions of a particular type may substantially affect the quality of a current diagnosis, prognosis, treatment evaluation, treatment selection, and/or treatment eligibility determination. As disclosed herein, such objective spatial characterization may be performed by detecting, from a digital pathology image, a set of biological object depictions and generating specified metrics based on the biological object depictions. The objects may be represented in accordance with one or more spatial analysis frameworks, including, but not limited to a spatial-areal analysis framework. In some cases, for each of a set of regions within an image and for each of one or more particular types of objects, metadata may be stored that indicates a quantity or density of depictions of biological objects of each particular type predicted or determined to be located within the region.

Spatial aggregation may include measures of how objects within the digital pathology image are spatially aggregated or distributed over an entire digital pathology image or over a region of the digital pathology image. For example, it may be advantageous to determine an extent to which biological objects of one type or class (e.g., lymphocytes, CD8+ T cells) are spatially comingled with biological objects of another type or class (e.g., tumor cells, CK+ cells). To illustrate, intra-tumoral tumor-infiltrating lymphocytes (“TILs”) are located within a tumor and have direct interaction with tumor cells, while stromal TILs are located in the tumor stroma and do not have direct interaction with tumor cells. Not only do intra-tumoral TILs have different activity patterns than stromal TILs, but each cell type may be associated with a different type of microenvironment further influencing the differences in behavior between the types of TILs. If a lymphocyte is detected at a particular location (e.g., within a tumor), the fact that the lymphocyte was able to infiltrate the tumor may convey information about the activity of the lymphocyte and/or of the tumor cells. Further, the microenvironment may affect the current and future activity of the lymphocyte. Identifying relative locations of biological objects of particular types may be particularly informative for predictive applications, such as identifying prognoses and treatment options, evaluating the eligibility of patients for clinical trials, and typifying immunological characteristics of the subject and their condition.

As another form of objective characterization of the locations and relations of detected biological object depictions, the detected biological object depictions may be used to generate one or more spatial-distribution metrics, which may characterize, at a region-, image- and/or subject-level, an extent to which biological objects of a given type or class are predicted as being interspersed with biological objects of another type or class, clustered with other objects of a same type, and/or clustered with biological objects of another given type. For example, a digital pathology image processing system may detect a first set of biological object depictions and a second set of biological object depictions in a digital pathology image. The system may predict that each of the first set of biological object depictions depicts a biological object of a first type (e.g., lymphocyte) and that each of the second set of biological object depictions depicts a biological object of a second type (e.g., tumor cell). The digital pathology image processing system may perform a clustering-based assessment to generate a spatial-distribution metric that indicates an extent to which individual biological object depictions in the first set of biological object depictions are spatially integrated with or separated from individual biological object depictions in the second set of biological object depictions and/or an extent to which the first set of biological object depictions (e.g., collectively) are spatially integrated with or separated from the second set of biological object depictions (e.g., collectively). As disclosed herein, a variety of spatial-distribution metrics have been developed and applied for this purpose.

Continuing the example of evaluation of CD8+ T cells within tumor beds, analysis may begin with the exposure of a particular sample to one or more stains known to be reactive with CD8+ T cells and CK+ tumor cells including, but not limited to a dual-chromogenic immunohistochemical assay to detect and outline epithelial cells. Once exposed, digital pathology images of the sample may be taken, such as according to techniques described herein. The digital pathology images of the samples may be categorized based on the density of the CD8+ T cells within the image, and in particular, within regions of the image appearing to include CK+ tumor cells. Categorization may be performed in a robustly automated and repeatable fashion or in a subjective manual fashion. This categorization may include, for example, a subjective measure from 0 (corresponding to very few effective cells) to 3 or more (corresponding to dense immune infiltrate). In certain embodiments, categorization may be performed according to the pattern of infiltrated cells, such as away from the CK+ tumor cells or partial or complete overlap between CD8+ and CK+ tumor cells. The resulting categorization may include desert (e.g., sparse CD8+ infiltration, independent of spatial distribution), excluded (e.g., very little overlap of CD8+ T cells and CK+ tumor cells, wherein distribution of CD8+ T cells is limited to the CK− stromal compartment, as depicted by a spatial separation of the tumor cells and the immune cells), or inflamed (e.g., co-localization of CD8+ T cells with CK+ tumor cells with large amounts of overlap). While, as mentioned, the evaluation process may be performed manually, manual evaluation is rife with sources of errors. First, the evaluation is performed subjectively and, even when attempts are made to add rigidity to the evaluation, such as cutoff metrics for each categorization type, the evaluation is still subject to subjective performance by a human evaluator. Second, the evaluation is subject to intra-tumoral heterogeneity in which multiple images generated from the same sample, or multiple samples imaged from the same tumor, are categorized differently based on different depictions of the biological objects therein. It may be difficult to correlate or otherwise account for these variances in categorization in manual approaches, particularly in large specimens. Additionally, the automated digital approaches discussed herein account for significantly more variables with repeatable results, broadening the factors under analysis through the use of spatial-distribution metrics. Although described in the context of evaluation of immunophenotype according to presence and density of CD8+ T cells in CK+ tumor cells, similar principles may apply where exposure of the sample to one or more stains may allow biological objects of differing types to be expressed in digital pathology images of a sample.

Principles and quantitative methods from advanced analytics (e.g., spatial statistics) may be applied to generate novel solutions related to the analysis of digital pathology images for categorization and predictive purposes. Techniques provided herein may be used to process a digital pathology image to generate a result that characterizes a spatial distribution and/or spatial pattern of depicted objects (e.g., biological objects) of one or more particular types or classes. The processing may include detecting depictions of biological objects of each of multiple particular types (e.g., corresponding to biological cells of each of multiple types) and/or specialized image segmentation on a region or pixel level. The object detection may include identifying, for each region of a set of regions within the digital pathology image and for each of the multiple particular biological object types, a higher-order metric that is defined to be reliant on and correlated with a quantity or lower-order metric of biological objects (e.g., a count, density, or image intensity that is inferred to represent a quantity of biological objects of the particular type presented within a corresponding image region). Moreover, the spatial-distribution metrics may be used in combination with other metrics (e.g., RNA sequencing, radiology imaging (CT, MRI, etc.)) to improve their predictive capabilities or to uncover novel biomarkers for unmet medical needs.

An image location of one or more biological object depictions may be determined. The image locations may be determined and represented in accordance with one or more spatial analysis frameworks, such as a spatial-areal analysis framework. As an example, a biological object depiction may be collectively represented with or indicated by one or more other biological object depictions as contributing to a count of objects detected within a particular region of the image, a density of the biological objects detected within the particular region of the image, a pattern of the biological objects detected within the particular region of the image, etc.

A digital pathology image processing system may use spatial-distribution metrics to facilitate identification of, for example, a diagnosis, prognosis, treatment evaluation, treatment selection, and/or treatment eligibility (e.g., eligibility of a subject to be accepted or recommended for a clinical trial or a particular arm of the clinical trial). For example, particular prognoses may be identified in response to detecting a certain degree of infiltration of CD8+ T cells into CK+ tumor cells. As another example, a diagnosis of a tumor or cancer stage may be informed based on an extent to which immune cells (e.g., CD8+ T cells) are spatially integrated with cancerous cells (e.g., CK+ tumor cells). As yet another example, a treatment efficacy may be determined to be higher when a spatial proximity of CD8+ T cells relative to CK+ tumor cells is small after commencing treatment relative to before treatment or relative to a projected proximity based on one or more prior assessments performed for a given subject.

Biological object detection (or detection of depicted biological objects) may be used to produce a result, which may include or may be based on a spatial distribution metric, that may indicate proximities between depictions of biological objects of the same or different types and/or an extent of co-localization of depictions of biological objects of one or more types. Co-localization of depictions of biological objects may represent similar locations of multiple cell types within each of one or more regions of the digital pathology image. The result may be indicative and/or predictive of interactions between different biological objects and types of biological objects that may be occurring within a microenvironment of a structure in a subject or patient that is indicated by the sample collected from the subject or patient. Such interactions may be supportive of and/or essential for biological processes, such as tissue formation, homeostasis, regeneration processes or immune responses, etc. The spatial information conveyed by the result may thus be informative as to the function and activity of particular biological structures and may thus be used as a quantitative underpinning to categorize the sample or characterize a disease state and prognosis or predict treatment efficacy and other subject outcomes.

Multiple spatial-distribution metrics may be generated. For example, one or more metrics may be generated using a spatial-areal analysis framework. The metrics may characterize counts or densities of depictions of biological objects of a first type within various image regions relative to counts or densities of other depictions of biological objects of a second type.

A machine-learning model or rule may be used to generate a result corresponding, for example, to a diagnosis, prognosis, treatment evaluation, treatment selection, treatment eligibility (e.g., eligibility to be accepted or recommended for a clinical trial or a particular arm of a clinical trial), and/or prediction of a genetic mutation, gene alteration, biomarker expression levels (including, but not limited to genes or proteins), etc., using one or more metrics, which each correspond to a metric type of one or more metric types. The machine-learning model may include, by way of example and not limitation, a classification, regression, decision-tree or neural-network technique that is trained to learn one or more weights to use when processing the metrics to produce the result. Moreover, a machine-learned model or rule may be trained to predict or recommend modifications to procedures for classifying or categorizing samples, such as modifications to infiltration and density metrics which may form cut-offs and/or thresholds for classification into one or more immunophenotypes.

A digital pathology image processing system may further identify and learn to recognize patterns of locations and relationships of detected biological object depictions based in part on one or more spatial-distribution metrics. For example, the digital pathology image processing system may detect patterns of locations, densities, and relationships of detected biological object depictions in a digital pathology image of a first sample. The digital pathology image processing system may generate a mask, or other pattern storage data structure, from recognized patterns. The digital pathology image processing system may predict a diagnosis, prognosis, treatment evaluation, treatment selection, and/or treatment eligibility determination using the image analysis principles and the spatial-distribution metrics as described herein. The digital pathology image processing system may store the predicted prognosis, etc. in association with the detected pattern(s) and/or the generated mask. The digital pathology image processing system may receive a subject outcome to validate the predicted prognosis, etc.

The digital pathology image processing system can, when processing a second digital pathology image from a second sample, detect patterns of locations and relationships of detected biological object depictions in the second digital pathology image. The digital pathology image processing system may recognize a similarity between the patterns of locations and relationships detected in the second digital pathology image and the mask or stored detected pattern from the first digital pathology image. The digital pathology image processing system may inform a predicted prognosis, treatment recommendation, or treatment eligibility determination based on the recognized similarity and/or subject outcome. As an example, the digital pathology image processing system may compare the stored mask to the pattern of locations and relationships of detected biological object depictions in the second digital pathology image. The digital pathology image processing system may determine one or more spatial-distribution metrics for the second digital pathology image and base the comparison of the stored mask to the recognized patterns from the second digital pathology image on a comparison of the spatial-distribution metrics of the detected biological object depictions in the first digital pathology image and the second digital pathology image.

Additionally or alternatively, the digital pathology image processing system may further use the spatial-distribution metrics and/or the immunophenotype assigned to a digital pathology image and/or sample to facilitate identification of a treatment selection. For example, immunotherapy may be selectively recommended upon determining a particular immunophenotype. The recommended therapy may be recommended upon comparison to studies of long-term and/or overall survival statistics associated with other subjects with similar immunophenotyping. Moreover, the recommendation may be refined using the particulars of the spatial-distribution metrics used to arrive at the conclusion of an immunophenotyping, advancing the sophistication of the recommendation.

Facilitating identification of a diagnosis, prognosis, treatment evaluation, treatment selection, and/or treatment eligibility, may include automatically generating a potential diagnosis, prognosis, treatment evaluation and/or treatment selection. The automatic identification may be based on one or more learned and/or static rules. A rule may have an if-then format which may include, in the condition, an inequality and/or one or more thresholds which may indicate, for example, that a metric above a threshold is associated with a suitability of a particular treatment. A rule may alternatively or additionally include a function, such as a function that relates a numeric metric to a severity score for a disease or a quantified score of eligibility for a treatment. The digital pathology image processing system may output the potential diagnosis, prognosis, treatment evaluation, treatment selection, and/or treatment eligibility determination as a recommendation and/or prediction. For example, the digital pathology image processing system may provide the output to a locally-coupled display, transmit the output to a remote device or access terminal a remote device, store the result in local or remote data storage, etc. In this manner, a human user (e.g., a physician and/or medical-care provider) may use the automatically generated output or form a different assessment informed by the quantitative metrics discussed herein.

Facilitating identification of a diagnosis, prognosis, treatment evaluation, treatment selection, and/or treatment eligibility determination may include outputting the spatial-distribution metric consistent with the disclosed subject matter. For example, an output may include an identifier of a subject (e.g., a name of a subject), stored clinical data associated with the subject (e.g., a past diagnosis, possible diagnosis, current treatment, symptoms, test results, and/or vital signs) and determined spatial-distribution metrics. The output may include a digital pathology image from which the spatial-distribution metric(s) were derived and/or a modified version thereof. For example, a modified version of the digital pathology image may include an overlay and/or markings that identify each biological object depiction detected in the digital pathology image and/or identify density of the biological object depictions detected in the digital pathology image and/or one or more regions of the image. The modified version of the digital pathology image may further provide information about the detected biological object depictions. A human user (e.g., a physician and/or medical-care provider) may then use the output, including the spatial-distribution metrics, to identify or verify a recommended diagnosis, prognosis, treatment evaluation, treatment selection, or treatment eligibility determination.

Multiple types of spatial-distribution metrics are generated using biological object depictions detected from a single digital pathology image. The multiple types of spatial-distribution metrics may be used in combination according to the subject matter disclosed herein. The multiple types of spatial-distribution metrics may correspond to the same or different frameworks relating to, for example, how a location of each biological object depiction is characterized. The multiple types of spatial-distribution metrics may include different variable types (e.g., calculated using different algorithms) and may be presented on different value scales. The multiple types of spatial-distribution metrics may be collectively processed using a rule or machine-learning model to generate a label. The label may correspond to a predicted diagnosis, prognosis, treatment evaluation, treatment selection, and/or treatment eligibility determination.

The term “biological object,” as referred to herein, may refer to a biological unit. A biological object may include, by way of example and not limitation, a cell, an organelle (e.g., a nucleus), a cell membrane, stroma, a tumor, or a blood vessel. It will be appreciated that a biological object may include a three-dimensional object, and a digital pathology image may capture only a single two-dimensional slice of the object, which need not even fully extend across an entirety of the object along a plane of the two-dimensional slice. Nonetheless, references herein may refer to such a captured portion as depicting a biological object.

The term “type of biological object,” or biological object type, as referred to herein, may refer to a category of biological units. By way of example and not limitation, a type of biological object may refer to cells (generally), a particular type of cell (e.g., lymphocytes or tumor cells), particular categorizations of types of cells (e.g., CD8+ T cell or CK+ tumor cell) cell membranes (generally), etc. Some disclosures may refer to detecting biological object depictions corresponding to a first type of biological object and other biological object depictions corresponding to a second type of biological object. The first and second types of biological object may have similar, same, or different levels of specificity and/or generality. For example, the first and second types of biological objects may be identified as lymphocyte and tumor cell types, respectively. As another example, a first type of biological object may be identified as lymphocytes, and a second type of biological object may be identified a tumor.

The term “spatial-distribution metric,” as referred to herein, may refer to a metric that characterizes a spatial arrangement of particular biological object depictions in an image relative to each other and/or relative to other particular biological object depictions. The spatial-distribution metric may characterize an extent to which biological objects of one type (e.g., lymphocytes) have infiltrated another type of biological object (e.g., a tumor), are interspersed with objects of another type (e.g., tumor cells), are physically proximate with objects of another type (e.g., tumor cells) and/or are co-localized with objects of another type (e.g., tumor cells).

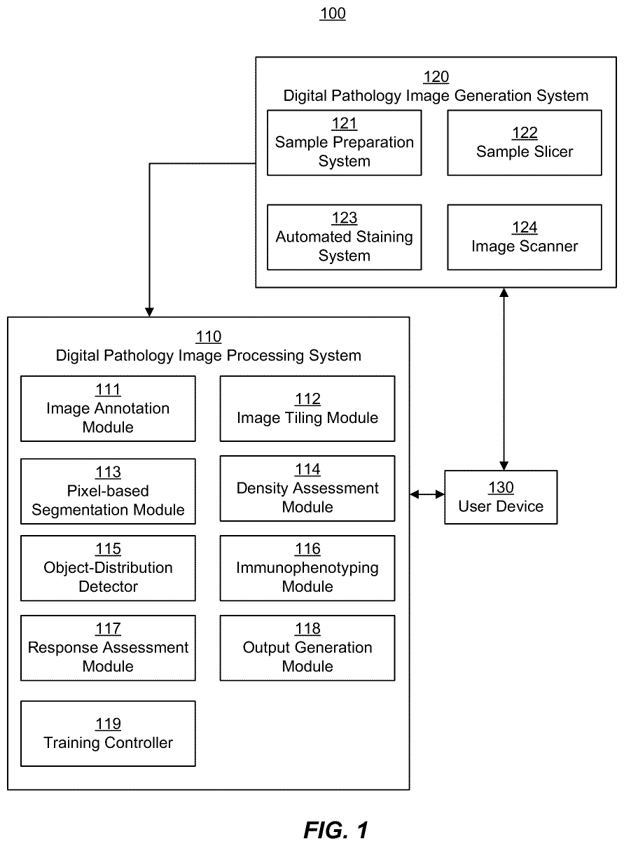

FIG. 1 shows an interaction system or network 100 of interacting system (e.g., specially-configured computer systems) that may be used, according to the disclosed subject matter, for generating and processing digital pathology images to characterize relative spatial information of biological objects.

A digital pathology image generation system 120 may generate one or more digital images corresponding to a particular sample. For example, an image generated by digital pathology image generation system 120 may include a stained section of a biopsy sample. As another example, an image generated by digital pathology image generation system 120 may include a slide image (e.g., a blood film) of a liquid sample. As another example, an image generated by digital pathology image generation system 120 may include fluorescence microscopy such as a slide image depicting fluorescence in situ hybridization (FISH) after a fluorescent probe has been bound to a target DNA or RNA sequence.

Some types of samples (e.g., biopsies, solid samples and/or samples including tissue) may be processed by a sample preparation system 121 to fix and/or embed the sample. Sample preparation system 121 may facilitate infiltrating the sample with a fixating agent (e.g., liquid fixing agent, such as a formaldehyde solution) and/or embedding substance (e.g., a histological wax). For example, a fixation sub-system may fixate a sample by exposing the sample to a fixating agent for at least a threshold amount of time (e.g., at least 3 hours, at least 6 hours, or at least 12 hours). A dehydration sub-system may dehydrate the sample (e.g., by exposing the fixed sample and/or a portion of the fixed sample to one or more ethanol solutions) and potentially clear the dehydrated sample using a clearing intermediate agent (e.g., that includes ethanol and a histological wax). An embedding sub-system may infiltrate the sample (e.g., one or more times for corresponding predefined time periods) with a heated (e.g., and thus liquid) histological wax. The histological wax may include a paraffin wax and potentially one or more resins (e.g., styrene or polyethylene). The sample and wax may then be cooled, and the wax-infiltrated sample may then be blocked out.

A sample slicer 122 may receive the fixed and embedded sample and may produce a set of sections. Sample slicer 122 may expose the fixed and embedded sample to cool or cold temperatures. Sample slicer 122 may then cut the chilled sample (or a trimmed version thereof) to produce a set of sections. Each section may have a thickness that is (for example) less than 100 μm, less than 50 μm, less than 10 μm, or less than 5 μm. Each section may have a thickness that is (for example) greater than 0.1 μm, greater than 1 μm, greater than 2 μm, or greater than 4 μm. The cutting of the chilled sample may be performed in a warm water bath (e.g., at a temperature of at least 30° C., at least 35° C. or at least 40° C.).

An automated staining system 123 may facilitate staining one or more of the sample sections by exposing each section to one or more staining agents (e.g., hematoxylin and eosin, immunohistochemistry, or specialized stains). Each section may be exposed to a predefined volume of staining agent for a predefined period of time. In particular cases, a single section is concurrently or sequentially exposed to multiple staining agents.

Each of one or more stained sections may be presented to an image scanner 124, which may capture a digital image of the section. Image scanner 124 may include a microscope camera. The image scanner 124 may capture the digital image at multiple levels of magnification (e.g., using a 10× objective, 20× objective, 40× objective, etc.). Manipulation of the image may be used to capture a selected portion of the sample at the desired range of magnifications. Image scanner 124 may further capture annotations and/or morphometrics identified by a human operator. In some cases, a section is returned to automated staining system 123 after one or more images are captured, such that the section may be washed, exposed to one or more other stains and imaged again. When multiple stains are used, the stains may be selected to have different color profiles, such that a first region of an image corresponding to a first section portion that absorbed a large amount of a first stain may be distinguished from a second region of the image (or a different image) corresponding to a second section portion that absorbed a large amount of a second stain.

It will be appreciated that one or more components of digital pathology image generation system 120 may operate in connection with human operators. For example, human operators may move the sample across various sub-systems (e.g., of sample preparation system 121 or of digital pathology image generation system 120) and/or initiate or terminate operation of one or more sub-systems, systems or components of digital pathology image generation system 120. As another example, part or all of one or more components of digital pathology image generation system (e.g., one or more sub-systems of sample preparation system 121) may be partly or entirely replaced with actions of a human operator.

Further, it will be appreciated that, while various described and depicted functions and components of digital pathology image generation system 120 pertain to processing of a solid and/or biopsy sample, other embodiments may relate to a liquid sample (e.g., a blood sample). For example, digital pathology image generation system 120 may receive a liquid-sample (e.g., blood or urine) slide, that includes a base slide, smeared liquid sample and cover. Image scanner 124 may then capture an image of the sample slide. Further embodiments of the digital pathology image generation system 120 may relate to capturing images of samples using advanced imaging techniques, such as FISH, described herein. For example, once a florescent probe has been introduced to a sample and allowed to bind to a target sequence appropriate imaging may be used to capture images of the sample for further analysis.

A given sample may be associated with one or more users (e.g., one or more physicians, laboratory technicians and/or medical providers). An associated user may include a person who ordered a test or biopsy that produced a sample being imaged and/or a person with permission to receive results of a test or biopsy. For example, a user may correspond to a physician, a pathologist, a clinician, or a subject (from whom a sample was taken). A user may use one or one more devices 130 to (for example) initially submit one or more requests (e.g., that identify a subject) that a sample be processed by digital pathology image generation system 120 and that a resulting image be processed by a digital pathology image processing system 110.

Digital pathology image generation system 120 transmits a digital pathology image produced by image scanner 124 back to user device 130, and user device 130 communicates with digital pathology image processing system 110 to initiate automated processing of the digital pathology image. Digital pathology image generation system 120 avails a digital pathology image produced by image scanner 124 to digital pathology image processing system 110 directly, e.g., at the direction of the user of a user device 130. Although not illustrated, other intermediary devices (e.g., data stores of a server connected to the digital pathology image generation system 120 or digital pathology image processing system 110) may also be used. Additionally, for the sake of simplicity only one digital pathology image processing system 110, digital pathology image generating system 120, and user device 130 is illustrated in the network 100. This disclosure anticipates the use of one or more of each type of system and component thereof without necessarily deviating from the teachings of this disclosure

Digital pathology image processing system 110 may analyze received digital pathology images, identify spatial characteristics of the digital pathology image, characterize a spatial distribution of biological object depictions therein, and/or provide a classification for the corresponding sample based on the analysis of the digital pathology image and the spatial characteristics of the digital pathology image.

An image annotation module 111 may generate and/or receive annotations of the digital pathology image. As example, the image annotation module may include one or more machine-learned and/or rules-based models for annotating the digital pathology image. The annotations of the digital pathology image may include to identify major structure (e.g., tumor bed including stroma and inflammation) shown within the digital pathology image. The major structures may be used to calibrate or normalize the processing of the digital pathology image by the remaining components of the digital pathology image processing system. In certain embodiments, the image annotation module 111 may generate a user interface for presentation to a user, such as a pathologist, to evaluate the digital pathology image and provide the annotations of the image or to provide a verification of annotations performed by an annotation model.

An image tiling module 112 may generate tiles from the digital pathology image. The digital pathology images may be provided in the form of whole slide images. Typically, whole slide images are significantly larger than standard images, and much larger than would normally be feasible for standard image recognition and analysis (e.g., on the order of 100,000 pixels by 100,000 pixels). To facilitate analysis, the image tiling module 112 subdivides each whole slide image into tiles. The size and shape of the tiles may be uniform for the purposes of analysis, but the size and shape may be variable. In some embodiments, the tiles may overlap to increase the opportunity for image context to be properly analyzed by the digital pathology image processing system 110. To balance the work performed with accuracy, it may be preferable to use non-overlapping tiles.

A pixel-based segmentation module 113 may generate image segmentations for the digital pathology image and/or tiles generated from the digital pathology image. In particular embodiments, the segmentation may be performed on a per-pixel basis, although regions of the digital pathology image larger than single pixels and smaller than tiles may be used. The pixel-based segmentation module 113 may use the properties of the digital pathology image to accurately segment the tiles generated from the digital pathology image, ideally into segments corresponding to various biological objects of interest. The pixel-based segmentation module 113 may use the intensity of color channels associated with one or more known effects of stains by which the sample corresponding to the digital pathology image have been treated. The various stains may be associated with particular color values, and these color values may correspond to certain known biological objects. As an example, a first stain may cause expression of CD8+ T cells with a strong brown color, due to reactivity with a CD8 IHC stain. The pixel-based segmentation module 113 may therefore identify pixels with a high intensity in color channels mapping to the brown color and relatively low intensities in other channels. These identified pixels may be part of the segmented channels associated with CD8+ T cells. Similarly, a second stain may cause expression of CK+ tumor cells with a strong magenta color, due to reactivity with a PanCK IHC stain. The pixel-based segmentation module 113 may therefore identify pixels with a high intensity in color channels mapping to the magenta color and relatively low intensities in other channels and associated these pixels as part of the segmented channels associated with CK+ tumor cells. Although particular colors and color channels are discussed, other suitable color characterizations and color identifications are envisioned, in particular as different stains and types of stains are used. The pixel-based segmentation module 113 may use shapes, edges, patterns, and other properties of the digital pathology image to segment the tiles. Additional morphological operations may be performed to consolidate and identify regions associated with first biological objects (e.g., regions associated with CD8+ T cells) and regions associated with second biological objects (e.g., regions associated with CK+ tumor cells).

A density assessment module 114 may automatically detect density of depictions of particular object (e.g., biological objects) of one or more particular types in each of the segmented digital pathology image tiles. As described herein, object types may include, for examples types of biological structures, such as cells. For example, a first set of biological objects may correspond to a first cell type (e.g., CD8+ T cells, etc.), and a second set of biological objects may correspond to a second cell type (e.g., tumor cells, etc.) or to a type of biological structure (e.g., tumors, malignant tumors, etc.). The density detection may be based on the pixel-based segmentations of individual tiles. As an example, the density detection may include bucketing pixel-segmented regions of the tiles and counting or otherwise measuring the magnitude of pixels associated with certain biological objects relative to the presentation of pixel-segmented regions of the tiles associated with other biological objects. Additionally or alternatively, the density assessment module 114 may generate a tile-based local-density measurement by comparing the intensity or magnitude levels of biological objects detected within a tile to threshold levels. Based on the density assessment, the density assessment module 114 or one or more other modules of the digital pathology image processing system 110 may assign a classification for each tile that corresponds to whether one or more of the types of biological objects (e.g., CD8+ T cells, CK+ tumor cells) are more predominant in the particular tile. This classification may indicate, for example, the presence or absences of the types of biological objects (e.g., tiles may be classified as positive or negative for CD8+ T cells and positive or negative for CK+ tumor cells). The density values generated for each tile may be provided to the object-distribution detector 115.

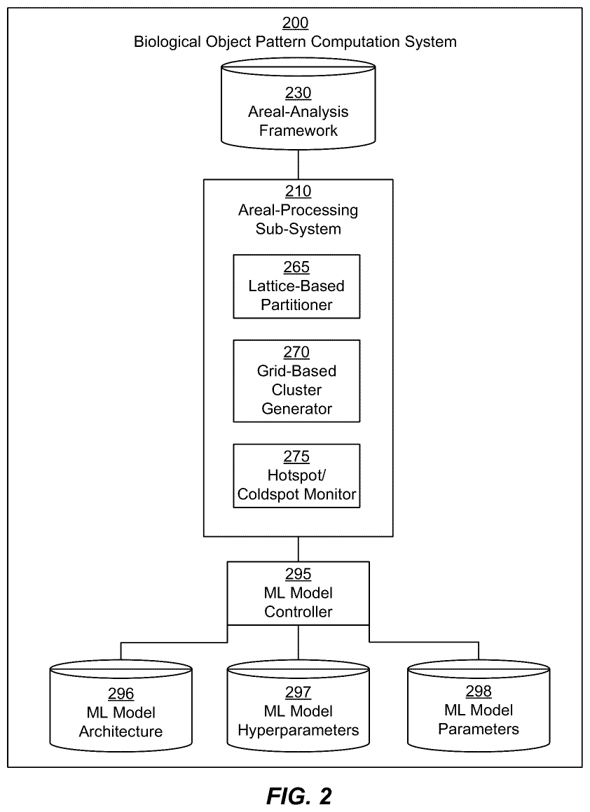

An object-distribution detector 115 may analyze the raw density values for the digital pathology image and generate one or more spatial-distribution metrics. The object-distribution detector 115 may use static rules and/or a trained model to detect and characterize the biological objects depicted in the tiles of the digital pathology image based, at least in part, on the density values. The object-distribution detector 115 may generate and/or characterize a spatial distribution of one or more objects and/or one tiles of the digital pathology image associated with a particular density of biological objects of a particular type. The distribution may be generated by (for example) using one or more static rules (e.g., that identify how to use absolute or smoothed counts or densities of biological objects within grid regions of a digital pathology image, etc.) and/or using a trained machine-learning model (e.g., which may predict that initial object-depiction data is to be adjusted in view of predicted quality of one or more digital pathology images). For example, the characterization may indicate an extent to which the biological objects of a particular type are depicted as being densely clustered with respect to each other, an extent to which depictions of biological objects of a particular type are spread across all or part of the image, how proximity of the depictions of biological objects of a particular type (relative to each other) compares to proximity of depictions of biological objects of another type (relative to each other), a proximity of depictions of biological objects of one or more particular types relative to depictions of biological objects of one or more other types, and/or an extent to which depictions of biological objects of one or more particular types are within and/or proximate to a region defined by one or more depictions of biological objects of one or more other types. As described in additional detail below in relation to FIG. 2, biological object-distribution detector 115 may initially generate a representation of the biological objects using a particular framework (e.g., a spatial-areal analysis framework, etc.).

In addition to using the density values prepared by the density assessment module 114, the object-distribution detector 115 may otherwise detect biological objects depicted in one or more tiles of the digital pathology image and prepare spatial-distribution metrics therefrom. Rules-based biological object detection may include detecting one or more edges, identifying a subset of edges that are sufficiently connected and closed in shape, and/or detecting one or more high-intensity regions or pixels. A portion of a digital pathology image may be determined to depict a biological object if, for example, an area of a region within a closed edge is within a predefined range and/or if a high-intensity region has a size within a predefined range. Detecting biological object depictions using a trained model may include employing a neural network, such as a convolutional neural network, a deep convolutional neural network and/or a graph-based convolutional neural network. The model may have been trained using annotated images that included annotations indicating locations and/or boundaries of objects. The annotated images may have been received from a data repository (e.g., a public data store) and/or from one or more devices associated with one or more human annotators. The model may have been trained using general-purpose or natural images (e.g., not solely images captured for digital pathology use or medical use generally). This may expand the ability of the model to differentiate biological objects of different types. It may have been trained using a specialized training set of images, such as digital pathology images, that have been selected for training the model to detect objects of a particular type.

Rules-based biological object detection and trained model biological object detection may be used in any combination. For example, rules-based biological object detection may detect depictions of one type of biological object while a trained model is used to detect depictions of another type of biological object. Another example may include validating results from rules-based biological object detection using biological objects output by a trained model or validating results of the trained model using a rules-based approach. Yet another example may include using rules-based biological object detection as an initial object detection, then using a trained model for more refined biological object analysis, or applying a rules-based object detection approach to an image after depictions of an initial set of biological objects are detected via a trained network.

For each detected biological object and/or each tile of the digital pathology image for which a density value has been generated, object-distribution detector 115 may identify and store a representative location of the depicted biological object (e.g., centroid point or midpoint), a set of pixels or voxels corresponding to an edge of the depicted object and/or a set of pixels or voxels corresponding to an area of the depicted biological object. This biological object data may be stored with metadata for the biological object which may include, by way of example and not limitation, an identifier of the biological object (e.g., a numeric identifier), an identifier of a corresponding digital pathology image, an identifier of a corresponding region within a corresponding digital pathology image, an identifier of a corresponding subject, and/or an identifier of the type of object.

An immunophenotyping module 116 may predict an immunophenotype for the sample depicted in the digital pathology image based on, at least in part, the tile classifications generated by the density assessment module 114 and the spatial-distribution metrics generated by the object-distribution detector for the digital pathology image. The immunophenotyping module 116 may include and/or use one or more machine-learned models or rules systems when making the assessment. As an example, a model may be learned through a supervised learning process based on training data including a set of digital pathology images, their associated tile classifications and spatial-distribution metrics, and known or preassigned immunophenotypes. As described herein, the object-distribution detector 115 may generate dozens of spatial-distribution metrics based on the density data of the tiles. The classifier may identify one or more hyperplanes to separate groups of digital pathology images (and underlying samples) in a feature space including the various spatial-distribution metrics. The process is referred to as a supervised learning process, because the set of immunophenotypes may be restricted to those specified for the particular type of tumor or biological structures. In certain embodiments, the learning may be an unsupervised process in which the model learns to classify the training data into an unspecified number or designation of groups on its own. Once trained, the model may be used by the immunophenotyping module 116 to evaluate live data (e.g., new inputs) and to group input digital pathology images into an appropriate immunophenotype.

A response assessment module 117 may use the spatial-distribution metrics and assigned immunophenotypes to generate one or more subject-level labels. Subject-level labels may include labels determined for an individual subject (e.g., patient), a defined group of subjects (e.g., patients with similar characteristics), an arm of a clinical study, etc. A label may correspond, for example, to a potential diagnosis, prognosis, treatment evaluation, treatment recommendation, or treatment eligibility determination. The label may be generated using a predefined or learned rule. For example, a rule may indicate that certain immunophenotypes are to be associated with particular treatment recommendations, a rule may indicate that a particular spatial-distribution metric above a predefined threshold is to be associated with a particular medical condition (e.g., as a potential diagnosis), while a metric below the threshold is not to be associated with the particular medical condition. As another example, a rule may indicate that a particular treatment is to be recommended when a spatial-distribution metric is within a predefined range (e.g., and not otherwise) and the assigned immunophenotype is one of two classes. As yet another example, a rule may identify different bands of treatment efficacy based on a ratio of a spatial-distribution metric corresponding to a recently collected digital pathology image over a stored baseline spatial-distribution metric corresponding to a digital pathology image collected less recently.

An output generation module 118 may generate multiple user interfaces, reports, and graphics corresponding to the digital pathology image, underlying sample, patient, or other unique association to convey the various assessments made by the digital pathology image processing system. As an example, the output generation module 118 may generate user interfaces or graphics corresponding to the annotations generated or received by the image annotation module 111. The annotations may be presented as an overlay to the original or edited digital pathology image. As another example, the output generation module 118 may generate an annotated or interactive representation of the digital pathology image based on the segmentations generated by the pixel-based segmentation module 113. Similarly, the output generation module 118 may generate heatmaps corresponding to the density values for each tile of the digital pathology image generated by the density assessment module 114. Additionally, the output generation module 118 may prepare reports of the immunophenotype(s) predicted for the digital pathology image by the immunophenotyping module 116 and/or the response assessments prepared by the response assessment module 117. In general the output generation module 118 may provide insight into the operations of the digital pathology image processing system 110 so assist in auditing the accuracy of the system as well as to assist pathologists or other researchers in understanding the mechanisms and reasons for particular assessments. The output may include a local presentation or a transmission (e.g., to user device 130).

A training controller 119 of the digital pathology image processing system 110 may control training of the one or more machine-learning models and/or functions used by the digital pathology image processing system 110. In some instances, some or all of the models and functions are trained together by training controller 119. In some instances, the training controller 119 may selectively train the models using by the digital pathology image processing system 110. As embodied herein, the training controller 119 may select, retrieve, and/or access training data that includes a set of digital pathology images and spatial-distribution metrics generated from the digital pathology images. The training data may further include a corresponding set of immunophenotypes that assigned for each digital pathology image. During training operations, the training controller 119 may cause the digital pathology image processing system to process and assign an immunophenotype and/or response assessment for a subset of the digital pathology images in the training data. The output for each of the digital pathology images may be compared to the predetermined immunophenotypes and/or outcomes for the training data. Based on the comparison, one or more scoring functions may be used to evaluate the levels of precision and accuracy of the machine-learning model(s) under testing. The training process will be repeated many times and may be performed with one or more subsets or cuts of the training data. For example, during each training cycle, a randomly-sampled selection of the digital pathology images from the training data may be provided as input.

As an example, training controller 119 may use a scoring function that penalizes variability or differences between the provided immunophenotypes and outcomes and the output generated by the immunophenotyping module 116 and response assessment module 117. Scoring functions may be devised, for example, to incentivize the system to learn to identify specific immunophenotypes or outcomes and/or specific criteria indicative of particular immunophenotypes or outcomes as described herein. The results of the scoring function may be provided to the machine-learning model being trained, which applies or saves modifications to the model to optimize the scores. After the model is modified, another training cycle begins with a new randomized sample of the input training data.

The training controller 119 further determines when to cease training. For example, the training controller 119 may determine to train the machine-learning model(s) or other algorithms used by the digital pathology image processing system for a set number of cycles. As another example, the training controller 119 may determine to train the digital pathology image processing system until the scoring function indicates that the models have passed a threshold value of success. As another example, the training controller 119 may periodically pause training and provide a test set of digital pathology images where the results are known. The training controller 119 may evaluate the output of the digital pathology image processing system 110 against the known results to determine the accuracy of the digital pathology image processing system. Once the accuracy reaches a set threshold, the training controller 119 may cease training.

Each component and/or system in FIG. 1 may include (for example) one or more computers, one or more servers, one or more processors and/or one or more computer-readable media. A single computing system (having one or more computers, one or more servers, one or more processors and/or one or more computer-readable media) may include multiple components depicted in FIG. 1. For example, digital pathology image processing system 110 may include a single server and/or collection of servers that collectively implements functionality of all of image annotation module 111, image tiling module 112, pixel-based segmentation module 113, density assessment module 114, object-distribution detector 115, immunophenotyping module 116, response assessment module 117, output generation module 118, and/or training controller 119.

FIG. 2 shows an illustrative biological object pattern computation system 200 for processing object data to generate spatial-distribution metrics. Object-distribution detector 115 may include part or all of system 200.

Biological object pattern computation system 200 may include multiple sub-systems, although only an areal-processing sub-system 210 is illustrated and described for emphasis. Each of the sub-systems may correspond to and use a different framework to generate spatial-distribution metrics or the constituent data thereof, such as an areal-analysis framework 230, a point-process analysis framework, a geostatistical framework, a graph framework etc. An areal analysis framework 230 may be a framework in which data (e.g., locations of depicted biological objects or densities of biological objects) is indexed using coordinates and/or a spatial lattice (e.g., tiles) rather than by individual biological object depictions. The areal analysis framework 230 may support generation of one or more metrics that characterize spatial patterns and/or distributions formed across depictions of one or more biological objects of each of one or more types.

The areal analysis framework 230 may index data using coordinates and/or a spatial lattice. The areal-processing sub-system 210 may apply the areal analysis framework 230 to identify or reference a density for each of a set of coordinates and/or regions associated with an image area. The density may be identified using one or more of a lattice-based partitioner 265, a grid-based cluster generator 270 and/or a hotspot monitor 275 or other techniques described herein.

Lattice-based partitioner 265 may impose a spatial lattice onto an image, including a representation of locations of depicted biological objects on an image. Imposing the spatial lattice onto the image may include segmenting the image into a plurality of tiles, such as by the image tiling module 112. The spatial lattice, including a set of rows and a set of columns, may define a set of regions (e.g., tiles), with each region corresponding to a row-column combination. Each row may have a defined height, and each column may have a defined width, such that each region of the spatial lattice may have a defined area.

Lattice-based partitioner 265 may determine an intensity metric using the spatial lattice and locations associated with each tile within the lattice. For example, for each lattice region, an intensity metric may indicate and/or may be based on an absolute or relative quantity or density of biological object depictions of each of one or more types within the region. The intensity metrics (e.g., densities) may be normalized and/or weighted based on a total number of biological objects (e.g., of a given type or of all types) detected within the tile, digital pathology image, and/or for the sample and/or a scale of the digital pathology image. In particular embodiments, the intensity metrics are smoothed and/or otherwise transformed. For example, initial counts may be thresholded, such that final intensity metrics are binary or presented on a normalized scale (e.g., 0 to 1, inclusive). A binary metric may include a determination whether a lattice region is associated with a density satisfying a threshold value (e.g., whether at least fifty percent of a tile includes pixels segmented as associated with a particular stain). Lattice-based partitioner 265 may generate one or more spatial-distribution metrics using areal data by (for example) comparing intensity metrics across different types of biological objects (e.g., comparing density of CD8+ T cells across tiles to density of CK+ tumor cells).

Grid-based cluster generator 270 may generate one or more spatial-distribution metrics based on cluster-related data pertaining to one or more biological object types. For example, for each of one or more biological object types, a clustering and/or fitting technique may be applied to determine an extent to which depictions of biological objects of the type (e.g., CD8+ T cells) are spatially clustered with, for example, each other and/or with depictions of biological objects of another type (e.g., CK+ tumor cells). The clustering and/or fitting technique may be further applied to determine an extent to which depictions of biological objects are spatially dispersed and/or randomly distributed. For example, grid-based cluster generator 270 may determine a Morisita-Horn index and/or Moran's index. A single metric may indicate an extent to which depictions of biological objects of one type are spatially clustered and/or proximate to depictions of objects of another type.

Hotspot/coldspot monitor 275 may perform an analysis to detect any “hotspot” locations of the digital pathology image at which depictions of biological objects of one or more particular types are likely to exist or any “coldspot” locations at which depictions of biological objects of one or more particular types are likely not to exist. The lattice-partitioned intensity metrics may be used to (for example) identify local intensity extrema (e.g., maximum or minimum) and/or fit one or more peaks, which may be characterized as hotspots, or one or more valleys, which may be characterized as coldspots. A Getis-Ord Hotspot algorithm may be used to identify any hotspots (e.g., intensities across a set of adjacent pixels high enough to be significantly different as compared to other intensities in the digital pathology image) or any coldspots (e.g., intensities across a set of adjacent pixels low enough to be significantly different as compared to other intensities in the digital pathology image). In particular embodiments, “significantly different” may correspond to a determination of statistical significance. Once object-type-specific hotspots and coldspots are identified, hotspot/coldspot monitor 275 may compare the location, amplitude, and/or width of any hotspots or coldspots detected for one biological object type with the location, amplitude, and/or width of any hotspots/coldspots detected for another biological object type.

It will be appreciated that various sub-systems may include components that are not depicted and may perform processing not explicitly described. For example, areal-processing-sub-system 210 may generate a spatial-distribution metric corresponding to an entropy-based mutual information measure to indicate an extent to which information about a location of a depiction of a biological object of a first type within a given region reduces an uncertainty about whether a depiction of another biological object (of a same or other type) exists at a location within another region. For example, a mutual information metric may indicate that locations of one biological object type provide information (and thus reduce the entropy) about the locations of another biological object type. Such mutual information may potentially be associated with instances in which cells of the one cell type are interspersed with cells of the other cell type (e.g., a tumor-infiltrating lymphocyte interspersed within tumor cells).

Biological object pattern computation system 200 may generate a result (which may itself be a spatial-distribution metric) using a combination of multiple (e.g., two or more, three or more, four or more, or five or more) spatial-distribution metrics (e.g., such as those disclosed herein) of various types. The multiple spatial-distribution metrics may include metrics generated using different frameworks (e.g., areal analysis framework 230) and/or metrics generated by different sub-systems. For example, spatial-distribution metrics may be generated using a Jaccard index, a Sørensen index, a B coefficient, a Moran's I calculation, a Geary's C calculation, a Morisita-Horn index metrics, Getis-Ord G index, a Colocation Quotient, or other similar spatial-distribution metrics for lattice- and tile-based frameworks.

The multiple metrics may be combined using one or more user-defined and/or predefined rules and/or using a trained model. For example, a machine-learning (ML) model controller 295 (separate from and/or integrated into the training controller 119) may train a machine-learning model so as to learn one or more parameters (e.g., weights) that specify how various lower level metrics are to be collectively processed to generate an integrated spatial-distribution metric. The integrated spatial-distribution metric may be more accurate in aggregate than the individual parameters alone. Additionally or alternatively, the machine-learning model controller 295 may train a machine-learning model to classify or otherwise make decisions regarding provided digital pathology image. Parameters regarding the machine-learning model may be stored in a ML model architecture data store. As an example, and as described herein, a machine-learning model may be trained to learn distance metrics and embeddings to separate classes of immunophenotypes based on a training set of data including spatial features and provided immunophenotype classifications. The machine-learning model may generate an embedding and feature space to separate classes of immunophenotypes based on calculated spatial distribution metrics. An architecture of the machine-learning model may also be stored in a ML model architecture data store 296. For example, a machine-learning model may include a logistic regression, a linear regression, a decision tree, a random forest, a support vector machine, a neural network (e.g., a feedforward neural network), etc., and ML model architecture data store 296 may store one or more equations defining the model. Optionally, a ML model hyperparameter data store 297 stores one or more hyperparameters that are used to define the model and/or its training but are not learned. For example, a hyperparameter may identify a number of hidden layers, dropout, learning rate, etc. Learned parameters (e.g., corresponding to one or more weights, thresholds, coefficients, etc.) may be stored in a ML model parameter data store 298.

While not shown in FIG. 2, biological object pattern computation system 200 may further include one or more components to aggregate spatial-distribution metrics across sections of a subject's sample and generate one or more aggregated spatial-distribution metrics. Such aggregated metrics may be generated (for example) by a component within a sub-system (e.g., by hotspot monitor 275), by a sub-system (e.g., by areal-processing sub-system 210), by ML model controller 295 and/or by biological object pattern computation system 200. An aggregated spatial-distribution metric may include (for example) a sum, median, average, maximum, or minimum of a set of section-specific metrics.

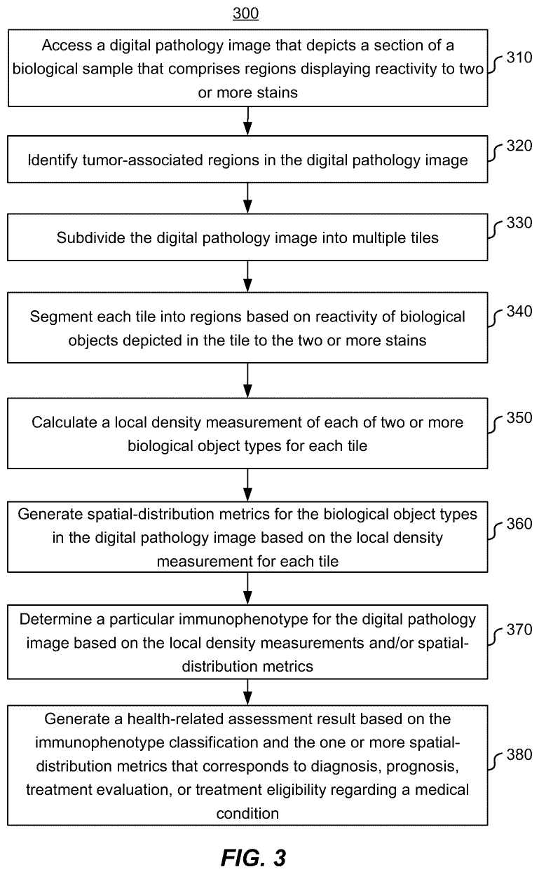

FIG. 3 illustrates a process 300 for classifying biological samples according to immunophenotype and providing health-related assessments based on image processing of digital pathology images using spatial-distribution metrics. More specifically, digital pathology images may be processed, e.g., by a digital pathology image processing system, to generate one or more metrics that characterize the spatial pattern(s) and/or distribution(s) of one or more types of biological objects. The spatial-distribution metrics may then inform diagnosis, prognosis, treatment evaluation, or treatment eligibility decisions.

The process begins at step 310, in which a digital pathology image processing system 110 may access one or more digital pathology images of a stained tissue sample. For example, the digital pathology image processing system 110 may receive a subject-associated identifier. The subject-associated identifier may include an identifier of a subject, of a sample, of a section and/or of a digital pathology image. The subject-associated identifier may be provided by a user (e.g., a medical provider for and/or a physician of a subject). The user may provide the identifier as input to a user device, which may transmit the identifier to the digital pathology image processing system 110. The digital pathology image processing system may query a local or remote data store may using the identifier to retrieve the digital pathology image. Additional or alternatively, the digital pathology image processing system 110 may receive the image directly from, e.g., a user device 130. As another example, a request that includes a subject-associated identifier may be transmitted to another system (e.g., a digital pathology image generation system 120), and a response may include the digital pathology image(s).

The digital pathology image may depict a stained section of a sample from the subject exhibiting a medical condition. The digital pathology image may be stained with more than one stain, as described herein, which are selected based on known reactivity properties with one or more types of biological objects (e.g., tumor cells and lymphocytes). As an example, the sample may be stained with particular stains, or other treatments, known to cause reactivity with tumor cells and lymphocytes, so as to improve the detectability of these biological objects and the related area of the digital pathology image.

At step 320, the digital pathology image processing system 110 may identify tumor-associated regions in the digital pathology image. In particular embodiments, the digital pathology image processing system 110 identifies the tumor-associated regions in the digital pathology image using a machine-learned model trained to identify tumor-associated regions within a digital pathology image. In particular embodiments, the digital pathology image processing system 110 identifies the tumor-associated regions in the digital pathology image through interactions of a pathologist or other user. As an example, the digital pathology image processing system 110 may provide a user interface for display including the digital pathology image and one or more interactive elements. The user interface may be provided, for example, to a user device 130 or through a user input device of the digital pathology image processing system 110. The digital pathology image processing system 110 may then receive a selection of the one or more tumor-associated regions through interaction with the one or more interactive elements.

At step 330, the digital pathology image processing system 110 may subdivide the digital pathology image into multiple tiles. The digital pathology images may be provided in the format of a whole slide image or other large format image. Because whole slide images are significantly larger than standard images, to facilitate analysis, the digital pathology image subdivides the digital pathology image into more manageable sizes referred to as tiles. The size and shape of the tiles may be uniform or may be variable based on the needs of the particular analysis. Additionally, while in some embodiments the tiles do not overlap (e.g., they are mutually exclusive of each other), in others, the tiles may overlap to increase the opportunity for image context to be properly analyzed by the digital pathology image processing system 110. The size and shape of the tiles may be determined automatically by the digital pathology image processing system 110 or may be predetermined by or at the request of one or more users (e.g., through input to the digital pathology image processing system 110 by a user device 130). In particular, the size and shape of the tiles, and of the lattice formed by the tiles, may be determined based on the type of analysis being performed, including the ultimate result assessment, the types of biological objects being sought, the type of tissue from which the biological sample was taken, the type of medical condition, or other related variables.

At step 340, the digital pathology image processing system 110 may segment each of the tiles into regions based on reactivity of biological objects depicted in the tile to the two or more stains to which the biological sample has been treated. In particular embodiments, the digital pathology image includes depictions of plurality of biological object types and each of the plurality of biological object types are reactive to one of the stains. The digital pathology image processing system 110 may apply pixel-based segmentation approaches to segment and classify the regions of the tiles based on a reactivity to the stains. As an example, each of the regions of the tiles may be set to the pixels that make up the tiles. The digital pathology image processing system 110 may classify each pixel as belonging to or containing one or more of the depicted biological object types based on the color of the region. For example, the digital pathology image processing system 110 may associate pixels with a threshold intensity in one or more first color channels (e.g., a brown color depicting regions reactive to a CD8 IHC stain) as being associated with a first biological object type (e.g., CD8+ T cells) and associate pixels with a threshold intensity in one or more second color channels (e.g., a magenta color depicting regions reactive to a PanCK IHC stain) as being associated with a second biological object type (e.g., CK+ tumor cells). The threshold intensity and particular color channels may be based on the particular stains to which the biological sample depicted in the digital pathology image the color being based on the reaction of each of the plurality of biological object types to one of the two or more stains. The association of the regions with particular biological object types may be further based on confidence scores of the image segmentation algorithm.

At step 350, the digital pathology image processing system 110 may calculate a local-density measurement of each of the biological object types for each tile of the digital pathology image. In some embodiments, the digital pathology image processing system 110 may classify a single tile as CK+(e.g., when the region(s) of tumor cells depicted in the tile as indicated by pixels depicting the PanCK IHC stain is greater than 25% of the window area) and/or CK− (e.g., when the presence of T cells as indicated by pixels depicting the CD8 IHC stain is greater than 25% of the window area), which allows for a given tile to be classified as both CK+ and CK−, as well as being classified solely as CK+ or CK−. From the local-density measurements, the digital pathology image processing system 110 may generate a data structure to include object information that characterizes the biological object depictions. The data structure may identify, for example, a location of the biological object depictions and/or location of the tile within the lattice of the digital pathology image. The data structure may further identify the type of biological object (e.g., lymphocyte, tumor cell, etc.) that corresponds to the depicted biological object. The calculation may be based the number of regions (e.g., areas of pixels) of the tile classified with each of the two or more stains (e.g., associated with each of the biological object types). In particular embodiments, the local-density measurement of each of the plurality of biological object types for each tile includes a representation of an absolute or relative quantity of biological object depictions of a first type of the biological object types identified as being located within the tile and an absolute or relative quantity of biological object depictions of a second type of the biological object types identified as being located within the tile. For example, in an example where there are two biological object types of interest, the local-density measurement may reflect the absolute number or percentage of the regions of each tile that are associated with each of the two biological objects types. This value may be divided by the overall number of regions within the tile to give a percentage of the tile associated with each of the biological object types. Additionally or alternative, the local-density measurement may be expressed as an area value based on a known conversion between the size of pixels of the digital pathology image and the corresponding size of the biological sample. In some embodiments, a two-dimensional density distribution of each biological object type (e.g., CK+ tumor cells and CD8+ T cells) may be obtained from the local-density measurement(s).

At step 360, the digital pathology image processing system 110 may generate spatial-distribution metrics for the biological object types in the digital pathology image based on the local-density measurement for each tile. Each of the spatial-distribution metrics characterizes a degree to which at least part of the first set of biological object depictions are depicted as being interspersed with at least part of the second set of biological object depictions. As described herein, the generated spatial-distribution metrics may include one or more of a Jaccard index, a Sørensen index, a Bhattacharyya coefficient, a Moran's index, a Geary's contiguity ratio, a Morisita-Horn index, a Colocation Quotient, a metric defined based on a hotspot/coldspot analysis, or variations of or modifications thereto.

In some embodiments, one or more spatial-distribution metrics may quantify spatial patterns of the biological objects, such as co-localization of biological object types, the presence of hotspots of one or more biological object types (including cells), etc. Such spatial patterns may help to assess a level of infiltration of lymphocytes into tumor regions (e.g., TILs). The spatial patterns may be quantified using one or more spatial analytic approaches based on a lattice of the digital pathology image. Each tile may be considered a spatial unit, and its center coordinate may be extracted. The total area of regions comprising a particular type of biological object may be calculated (e.g., based on the number of pixels depicting a stain color indicating a presence of the biological object type) for each tile and then normalized by dividing by the sum of all areas of the biological type across all tiles of the same slide (e.g., the sum of all areas depicting tumor regions across all tiles of the slide, or the sum of all areas depicting T cells across all tiles of the slide). One or more prevalence maps may be created, wherein the prevalence value for each tile may be based on the calculated normalized area of the biological object type. The spatial-distribution metrics may be derived from the prevalence map(s). The spatial-distribution metrics may represent, among others, the co-localization of two biological object types, such as TILs embedded amongst tumor cells, and/or the spatial distribution of one biological object type, such as TILs in tumor regions, respectively.

As described herein, the one or more spatial-distribution metrics may include one or more of: a Jaccard Index, Sørensen Index, Bhattacharyya coefficient, Moran's Index (including a bivariate Moran's Index, Moran's Index for CD8, and/or Moran's Index for CK), Geary's contiguity ratio or C Index (including Geary's C Index for CD8 and/or Geary's C Index for CK), Morisita-Horn Index, metric defined based on a hotspot/coldspot analysis (e.g., Getis-Ord hotspot (including a co-localized Getis-Ord hotspot, Getis-Ord hotspot for CD8, and/or Getis-Ord hotspot for CK)), a ratio of the areas of the biological objects (e.g., a ratio of the total area of CD8+ regions to the total area of CK+ regions), a Colocation Quotient, or variations of or modifications thereto.

At step 370, the digital pathology image processing system 110 may determine a particular immunophenotype for the digital pathology image based on the local-density measurements generated for the tiles of the digital pathology image and spatial distribution metrics generated for the digital pathology image. The digital pathology image processing system 110 may generate an embedding or other representation of the digital pathology image using the local-density measurements and spatial distribution metrics as input. As an example, the digital pathology image processing system 110 may project a representation of the digital pathology image into an embedding space or feature space defined by the spatial distribution metrics (e.g., having axes based on the one or more spatial-distribution metrics). The projection and feature space may be based on a machine-learning model trained to generate embeddings in an appropriate feature space. The digital pathology image processing system 110 may then classify the biological sample based on a position of the digital pathology image within the feature space. In particular, the digital pathology image processing system 110 may classify the digital pathology image based on a proximity of the position of the representation of the digital pathology image in the feature space to a position of one or more other digital pathology image representations. These neighboring digital pathology image representations may have pre-assigned or predetermined immunophenotype classifications. The digital pathology image may be assigned an immunophenotype based on the immunophenotypes of the nearest neighbors in the feature space.

At step 380, the digital pathology image processing system 110 may generate a health-related assessment result based on the immunophenotype classification and the one or more spatial-distribution metrics. The health-related assessment result may correspond, for example, to a diagnosis, prognosis, treatment evaluation, or treatment eligibility regarding a medical condition associated with the subject from whom the biological sample was taken. The digital pathology image processing system may process the immunophenotype classification and the one or more spatial-distribution metrics using a trained machine-learned model. As described herein, the machine-learned model may be trained to generate assessment results using a set of training elements, each corresponding to another subject having a similar medical condition and for which an outcome or classification relating to the health-related assessment is known. For example, if the health-related assessment is related to prediction of overall survival (or survival over a specified time period), each of the known outcomes for the subject may include information relating to survivability of the subjects. As another example, if the health-related assessment is related to availability of or eligibility for specific treatments (including, e.g., clinical trials), each of the known outcomes for the subjects may include information relating to exclusion or inclusion criteria or subject survival and recovery outcomes after the treatment.

In some embodiments, the digital pathology image processing system 110 may generate one or more outputs based on the local-density measurements, the spatial distribution metrics, the immunophenotype classification, or the health-related assessment result. The outputs may include one or more visualizations of the digital pathology image augmented based on the interim calculations or determinations of the digital pathology image processing system 110. As an example, a first output may include a heatmap visualization of the digital pathology image showing the prevalence of one or more of the biological object types observed by the digital pathology image processing system based on the local-density measurements calculated for each tiles of the digital pathology image processing system. As another example, a second output may include an overlay based on the calculated spatial-distribution metrics that relays information associated with the relationship between the distribution of the plurality of biological object types. As another example, a third output may include the results of the health-related assessment. The outputs may be provided, e.g., through a user interface displayed on the user device 130. One or more of the outputs may be provided directly to the subject, while certain outputs may be restricted only to medical professionals or limited to clinical or research environments.

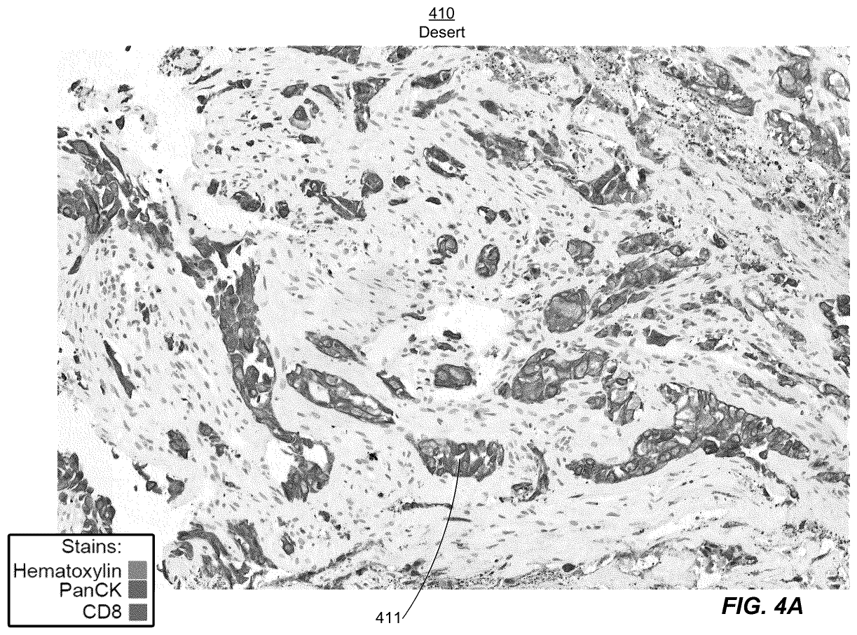

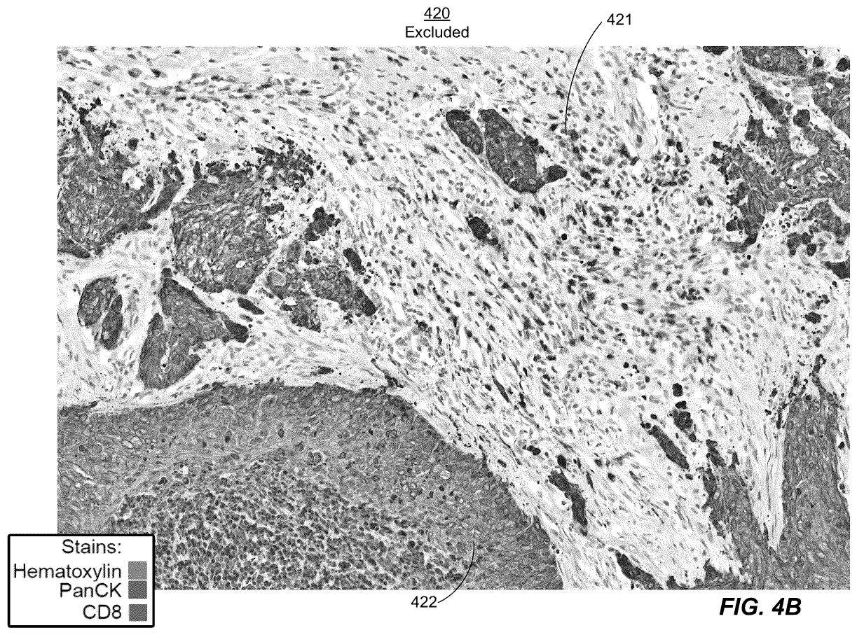

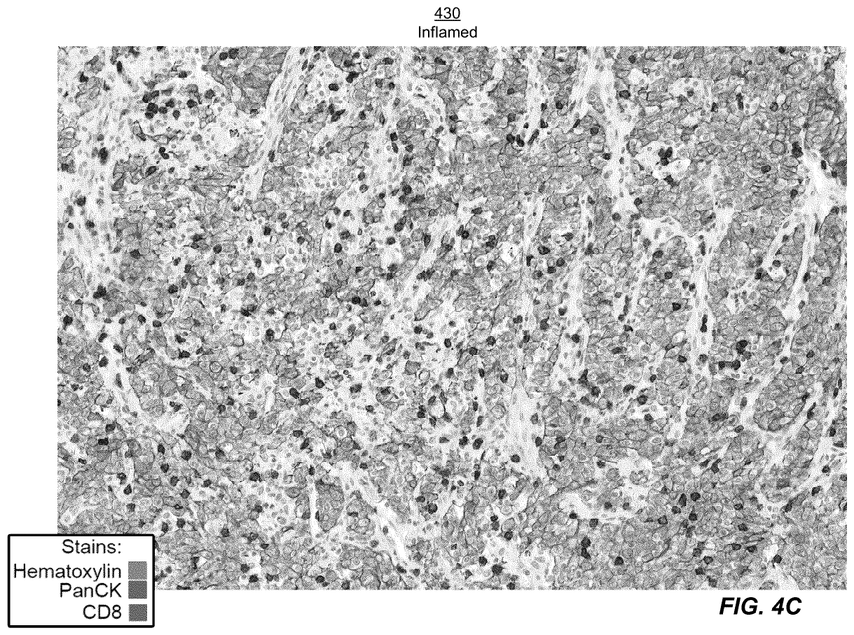

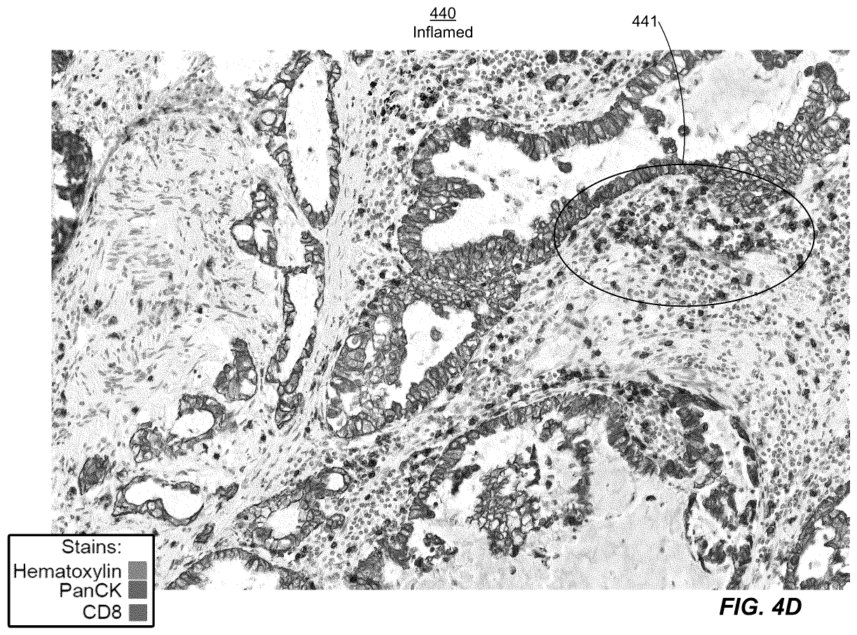

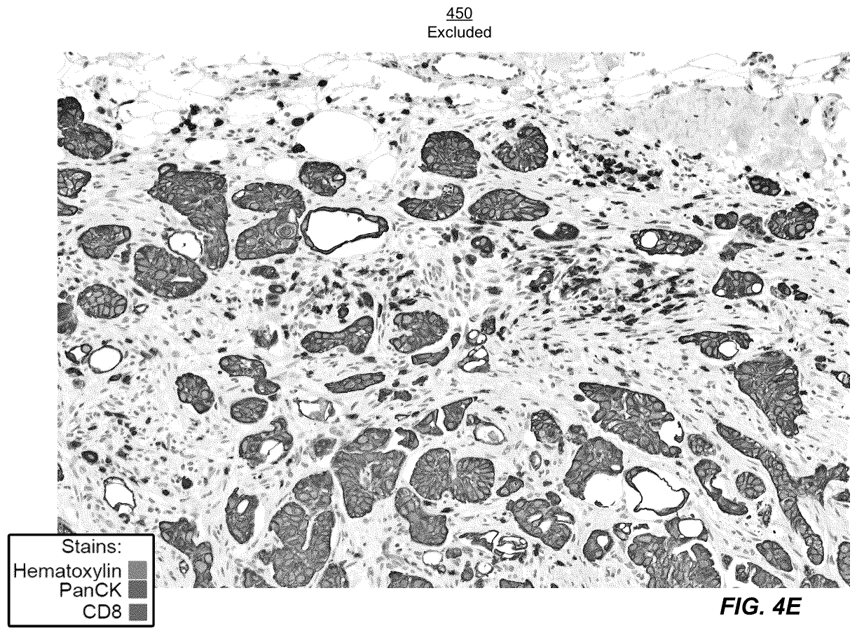

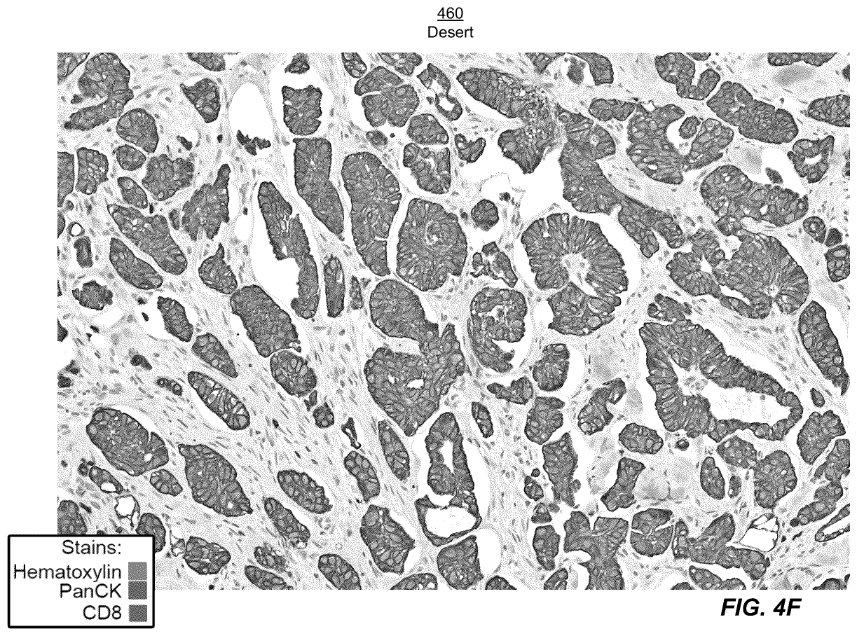

FIG. 4A illustrates several examples of immunophenotypes that may be associated with digital pathology images. As described herein, immunophenotypes, and particular immunophenotypes associated with CD8+ T cells related to infiltration within CK+ tumor cells, may include desert, excluded, and inflamed. Another type of digital pathology image may be referred to as indeterminate, because the digital pathology image from the sample does not follow otherwise known patterns. A digital pathology image may be classified as a desert immunophenotype when there is sparse CD8+ infiltrate (e.g., for the plurality of tiles, the local-density measurement of the immune cells is less than an immune-cell-density threshold). A digital pathology image may be classified as excluded when there is very little overlap of CD8+ T cells and CK+ tumor cells, or the distribution of CD8+ T cells is limited to CK-stroma compartment (e.g., for one or more of the plurality of tiles, the local-density measurement of the tumor cells is less than a tumor-cell-density threshold and the local-density measurement of the immune cells is greater than or equal to the immune-cell-density threshold; for one or more of the plurality of tiles, one or more spatial distribution metrics indicate a spatial separation of the tumor cells and the immune cells). Alternatively, a digital pathology may be classified as inflamed when there is co-localization of CD8+ T cells with CK+ tumor cells with large amounts of overlap (e.g., for one or more of the plurality of tiles, the local-density measurement of the tumor cells is greater than or equal to the tumor-cell-density threshold and the local-density measurement of the immune cells is greater than or equal to the immune-cell-density threshold; for one or more of the plurality of tiles, one or more spatial-distribution metrics indicate a co-localization of the tumor cells and the immune cells).

The digital pathology images of FIGS. 4A-4F may be images of samples from subjects having non-small cell lung cancer (NSCLC). The samples are formalin-fixed, paraffin-embedded (FFPE) sections that have been immunohistochemically (IHC) stained with CD8 used to identify T lymphocytes and PanCK used to indicate regions of malignant (and benign) epithelia. For example, the images may illustrate sections that react to the CD8 stain in brown (shown in a black and white figure with a mid-level of shading) with the sections that react to the PanCK stain in magenta (shown in a black and white figure with the darkest shading). In some embodiments, the images may illustrate sections that react to a third stain, such as hematoxylin, shown in blue (shown in a black and white figure with the lightest shading). The tumor-associated regions (in the digital pathology images) comprising viable malignant epithelia were identified by the digital pathology image processing system 110. Then, the digital pathology images were segmented into a plurality of tiles. The biological samples were classified with a tumor immunophenotype based on the spatial distribution and density of the CD8+ T cells.

Digital pathology image 410 (FIG. 4A) depicts an example of a desert immunophenotype. Although regions of CK+ tumor cells may be identified, such as region 411, the regions of CD8+ T cells are extremely sparse. Digital pathology image 420 (FIG. 4B) depicts an example of an excluded immunophenotype. In contrast with the desert immunophenotype associated with digital pathology image 410, the excluded immunophenotype includes regions of both CD8+ T cells (e.g., region 421) and regions of CK+ tumor cells (e.g., region 422). However, the regions are relatively separated. The CD8+ T cells are clustered together, but generally are not depicted as infiltrating the regions of tumor cells. As shown in the example image 420, the distribution of CD8+ cells may be limited to the CK− negative stromal compartment.

Digital pathology image 430 (FIG. 4C) depicts a first instance of the inflamed immunophenotype. Like the excluded immunophenotype, there are readily identifiable depictions of CD8+ T cells with the regions of tumor cells. However, upon inspection, the T cells have begun to more readily infiltrate the regions of the tumor cells, thereby demonstrating co-localization. In particular, the T cells are shown as being distributed largely throughout the digital pathology image 430. The “Type 1” tumors shown in the digital pathology image 430 may show a diffuse infiltrate involving CK+ areas with or without involvement of the stromal compartment.

Digital pathology image 440 (FIG. 4D) depicts a second instance of the inflamed immunophenotype. In this example, while there is still general infiltration of the CD8+ T cells throughout the tumor cells, the CD8+ T cells have begun to cluster, such as in the region 441. This degree of clustering may be one differentiating factor between the inflamed and excluded immunophenotypes. The “Type 2” tumors shown in the digital pathology image 440 may show a predominantly stromal pattern of the CD8+ infiltrate with “spill-over” into CK+ tumor cell aggregates. In some embodiments, a digital pathology image processing system 110 may classify abiological sample according to a sub-type, such as “Type 1” tumor or “Type 2” tumor.

FIGS. 4E and 4F illustrate additional examples of immunophenotypes that may be associated with digital pathology image. In particular, digital pathology images 450 and 460 are taken from the same sample. Digital pathology images 450 and 460 showcase the variability of immunophenotype manifestation and intra-tumoral heterogeneity of the density and pattern of the infiltrate, even with the same sample. Digital pathology image 450 shows an example of an excluded immunophenotype. As may be seen by comparison to the other examples, the digital pathology image 450 includes a comparatively small amount of the tumor cells, yet a large amount of the CD8+ T cells. Digital pathology image 460 (FIG. 4F) shows an example of a desert immunophenotype, having only extremely sparse CD8+ regions.

In some embodiments, a digital pathology image may be classified as having a certain tumor immunophenotype when a threshold percentage of the tumor region (e.g., a CK+ region) has a given pattern. For example, if the percentage of the tumor region showing an inflamed immunophenotype is greater than a pattern threshold (e.g., 20%), the digital pathology image may be classified as inflamed.

In certain embodiments, a digital pathology image may be classified as having a certain tumor immunophenotype based on the Colocation Quotient (CLQ). The CLQ may assess co-occurrence or avoidance of cell type pairs by measuring the local density of a target cell type at a fixed radius from each cell of the sample belonging to a reference cell type. For example, as applied to a digital pathology image, the CLQ assessment may facilitate determining whether CD8+ T cells (the target cell type) are co-locating with (inflamed) or avoiding (excluded) tumor cells (the reference cell type) by measuring the local density of CD8+ T cells at a fixed radius from each of the tumor cells. Thereby, a high mean local density of CD8+ T cells at a short fixed radius from each of the tumor cells corresponds to co-location, as will be observed with the inflamed category.

A digital pathology image may be classified as desert using a hard-cutoff threshold, a maximum percentage area occupied by immune cells, or any other suitable measure indicating a dearth of immune cells. For example, when a sample has less than a specified number of immune cells (e.g., 200 cells), the sample may be labeled as desert. The remaining samples may be rendered into two clusters with a two-component Gaussian mixture model that utilized CLQ_{immune→tumor} (the local density of tumor cells in the neighborhood of each immune cell) and CLQ_{tumor→immune} (the local density of immune cells in the neighborhood of each tumor cell) to distinguish between excluded and inflamed categories. The cluster with a larger mean value of CLQ_{immune→tumor} and CLQ_{tumor→immune} may be classified as inflamed. The remaining cluster may be classified as excluded.

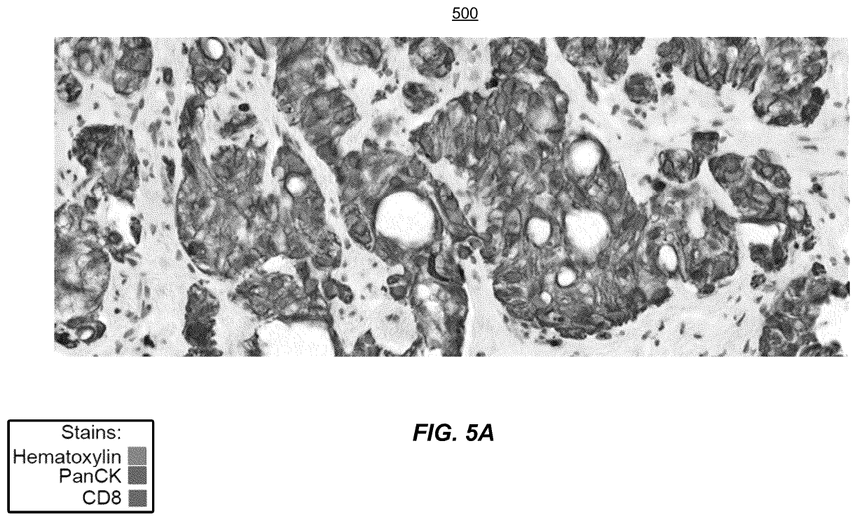

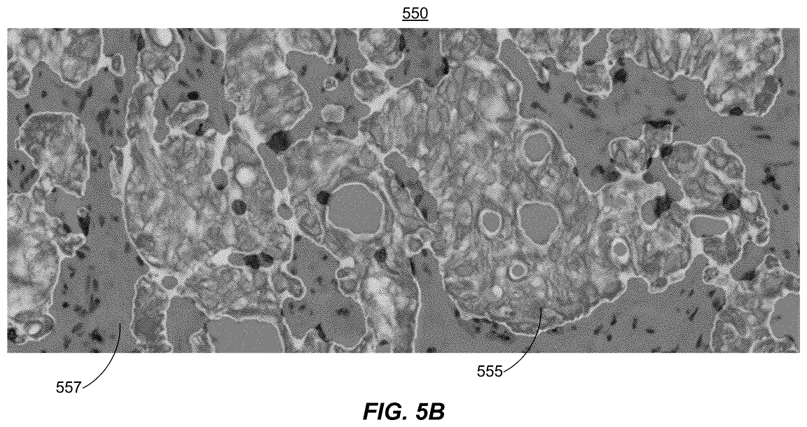

FIGS. 5A-5B illustrate an example of a pixel-based segmentation of CK+ tumor cells and CD8+ T cells. The digital pathology image 500 (FIG. 5A) shows a sample that has been treated with one or more stains which react with the CK+ tumor cells (which are reactive to the magenta PanCK stain) and CD8+ T cells (which are reactive to the brown CD8 stain). The stains cause expression of the biological objects based on the color of the biological object upon review. By analyzing the color of the individual pixels of the digital pathology image and/or the tiles of the digital pathology image, the digital pathology image processing system may separate the regions into those associated with CD8+ T cells, CK+ tumor cells, other biological structures, or no biological structures. As an example, the digital pathology image processing system 110, or one or more components thereof including, but not limited to, the pixel-based segmentation module 113, may perform color thresholding associated with the color channels known to be associated with stains applied to be effective against biological structures of interest. Additional morphological operations may be performed to consolidate and identify regions associated with first biological objects (e.g., regions associated with CD8+ T cells) and regions associated with second biological objects (e.g., regions associated with CK+ tumor cells). After the segmentation, output may be provided for the digital pathology image and/or tiles thereof, such as a score indicating an amount or percentage of the digital pathology image and/or of each tile that has been segmented into each of the various segments used for the present analysis. FIG. 5B shows an overlay view 550 of the digital pathology image 500, where the regions associated with CK+ tumor cells are highlighted (e.g., as in region 555) and regions not associated with CK+ tumor cells are deemphasized (e.g., as in region 557). The final association of pixels of the digital pathology image and/or tiles to particular segments associated with particular biological objects may be further based on threshold operations wherein a certain amount of pixels of each tile must exceed a certain intensity for any portion to be segmented to be associated with the particular biological objects. This thresholding operation may guide be particular impactful where the stain(s) used on the digital pathology image are reactive to more than one type of biological object.

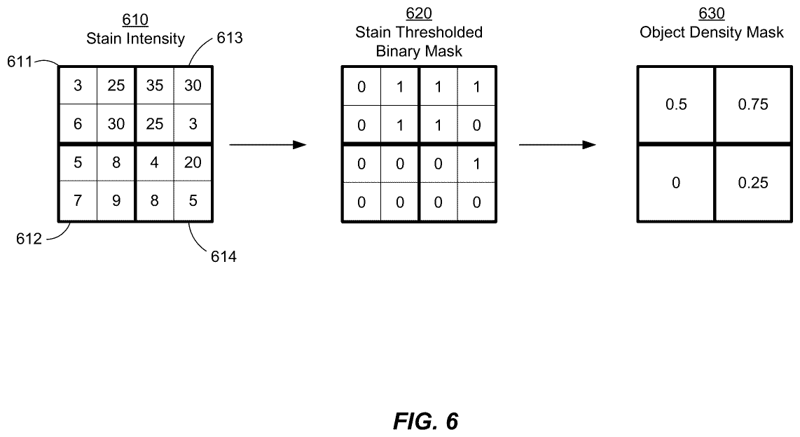

FIG. 6 depicts an example of a tile-based local-density measurement. FIG. 6 illustrates three masks 610, 620, and 630 that have been generated from a digital pathology image. The masks may be generated, for example, by the pixel-based segmentation module 113, density assessment module 114, or other suitable components of the digital pathology image processing system 110. Mask 610 is a stain intensity mask for the digital pathology image. The digital pathology image, and mask 610, has been divided into four tiles. Each tile includes four pixels. Each pixel is associated with a stain intensity value that corresponds to the intensity of a particular stain (e.g., the intensity of color channels known to be reflective of stain performance). The northwest tile 611 includes stain intensity values 3, 25, 6, and 30. The southwest tile 612 includes stain intensity values 5, 8, 7, and 9. The northeast tile 613 includes stain intensity values 35, 30, 25, and 3. The southeast tile 614 includes stain intensity values 4, 20, 8, and 5. As each of the stain intensity values is reflective of the performance of the stain (e.g., the rate of absorption or expression of the stain by the biological objects depicted in the corresponding pixels of the digital pathology image), the stain intensity values may be used to determine which biological objects are shown in the tiles—and the frequency of appearance.

Mask 620 is a stain thresholded binary mask for the stain intensity mask 610. Each individual pixel value of the stain intensity mask 610 has been compared to a predetermined and customizable threshold for the stain of interest. The threshold value may be selected accordingly to protocol reflective of the expected level of expression of stain intensity corresponding to a confirmed depiction of the correct biological object. The stain intensity values and threshold values may be absolute values (e.g., a stain intensity value above 20) or relative values (e.g., setting the threshold at the top 30% of stain intensity values). Additionally, the stain intensity values may be normalized according to historical values (e.g., based on overall performance of the stain on a number of previous analyses) or based on the digital pathology image at hand (e.g., to account for brightness differences and other imaging changes that may cause the image to inaccurately display the correct stain intensity). In the stain thresholded binary mask 620, the threshold has been set to a stain intensity value of 20 and applied across all pixels within the stain intensity mask 610. The result is a pixel-level binary mask with ‘1’ indicating that the pixel had a stain intensity at or exceeding the threshold value and ‘0’ indicating that the pixel did not satisfy the requisite stain intensity.

Mask 630 is an object density mask on the tile-level. Based on the assumption that stain intensity levels above the threshold correlate to depiction of a particular biological object within the digital pathology image, operations are performed on the stain thresholded binary mask 620 to reflect the density of biological object within each tile. In the example object density mask 630, the operations include summing the values of the stain thresholded binary mask 620 within each tile and dividing by the number of pixels within the tile. The northwest tile contained two pixels above the threshold stain intensity value out of a total of four pixels, therefore the value in the object density mask for the northwest tile is 0.5. Similar operations are applied across all tiles. Additional operations may be performed to, for example, preserve locality with each tile, such as sub-tile segmentation and preservation of coordinates of each sub-tile within the lattice. As described herein, the object density mask 630 may be provided to the object-distribution detector 115 as the basis for calculation of spatial-distribution metrics. It will be appreciated that the example depicted in FIG. 6 is simplified for discussion purposes only. The number of pixels within each tile and the number of tiles within each digital pathology image may be greatly expanded and adjusted as needed based on computational efficiency and accuracy requirements.

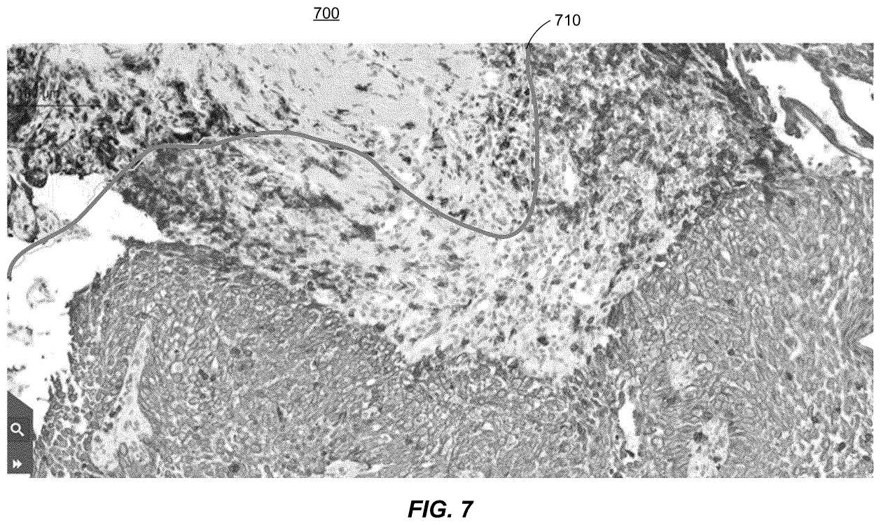

FIG. 7 illustrates an example annotated digital pathology image 700. In particular, the annotated digital pathology image 700 shows a line 710 separating the bottom portion of the digital pathology image 700 from the top portion. The separation indicates that the bottom portion of the digital pathology image 700 is associated with a tumor bed (e.g., including tumor tissue and stroma), while the top portion of the digital pathology image 700 above the line 710 is not associated with the tumor bed. As described herein, the segmentation line may be generated by the digital pathology image processing system 110 or received by the digital pathology image processing system 110 from a manual evaluation. Moreover, the annotation digital pathology image 700 may be provided as a form of output from the digital pathology image processing system 110. As described herein, multiple forms of output may be provided as a mechanism allowing reviewers to better under the approach adopted by the digital pathology image processing system 110 and how it arrived at ultimate conclusions. Output indicating the segmentation into tumor tissue and otherwise is a first step to ensuring that the digital pathology image processing system 110 correctly interpreted the digital pathology image and sample.

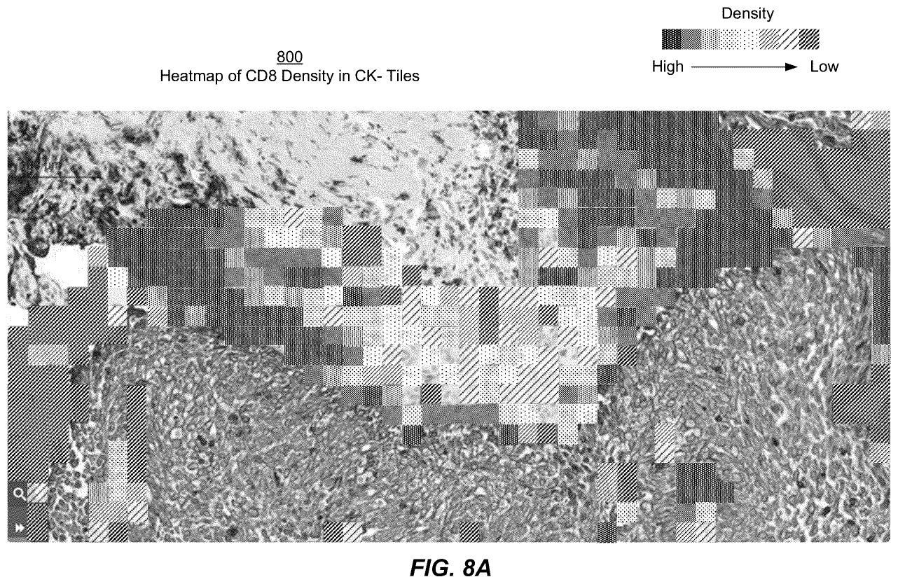

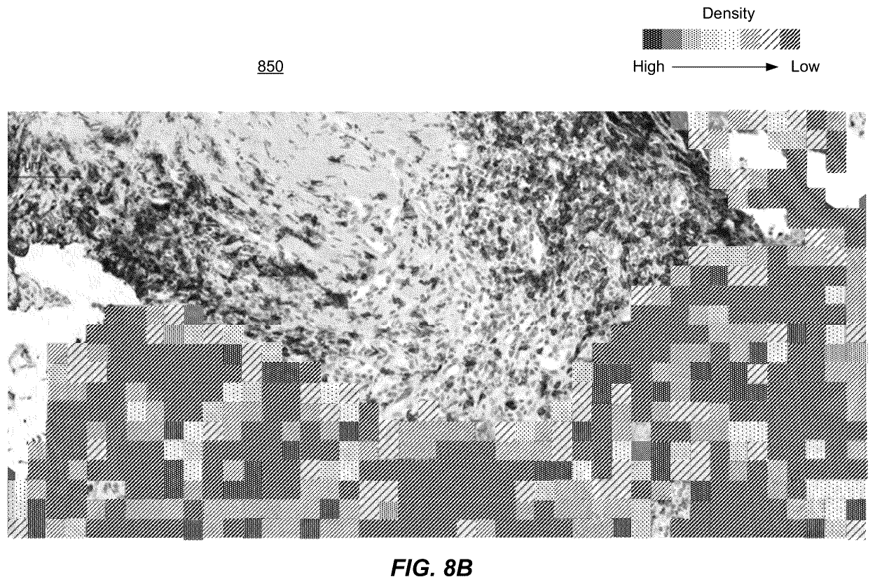

FIGS. 8A and 8B illustrate example heatmaps of biological object density for a particular type of biological object. Using a digital pathology image provided to the digital pathology image processing system 110, the digital pathology image processing system 110 has segmented the digital pathology image into tiles, performed a pixel-based segmentation, and generated initial density metrics (e.g., generated an object density mask for the digital pathology image). In the example depicted in FIGS. 8A and 8B, the digital pathology image processing system 110 has identified densities of CD8+ T cells in both CK− and CK+ regions. To assist with review of the output of the digital pathology image processing system 110, the output generation module 118 has created heatmap visualizations 800 and 850 based on the respective object density metrics. The heatmap visualization 800 shows the density of CD8+ T cells in CK− tumor cells (e.g., in tumor stroma). The heatmap visualization 850 shows the density of CD8+ T cells in CK+ tumor cells (e.g., within tumor tissue). The visualization may assist pathologists in systematically categorizing the sample shown in the digital pathology image and also assist in understand the immunophenotype assigned by the digital pathology image processing system 110.

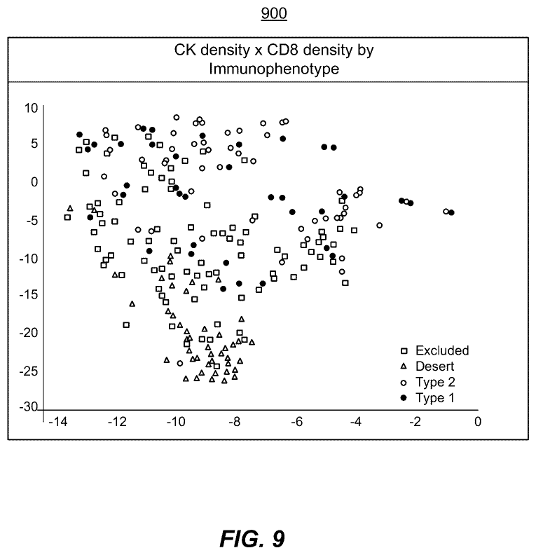

FIG. 9 illustrates a plotting of biological object density bins by immunophenotype. In particular, FIG. 9 illustrates a plot 900 showing a plotting of CK+ and CK− density values against CD8 density values. The plot 900 illustrates a first and naïve interpretation of the density scores that may be generated by the density assessment module 114. Although certain trends are determinable from the simple chart, such as the clustering of desert immunophenotypes lower in the y-axis and prevalence of inflamed immunophenotypes higher in both the x-axis and y-axis, it is difficult to draw further conclusions as additional clusters cannot be determined. Plot 900 therefore demonstrates the limitations of previous forms of analysis and the motivation of development of additional techniques to automatically classify digital pathology images and the tiles derived therefrom. These additional techniques include, according to embodiments described herein, the integration of advanced spatial distribution metrics derived from the density values.

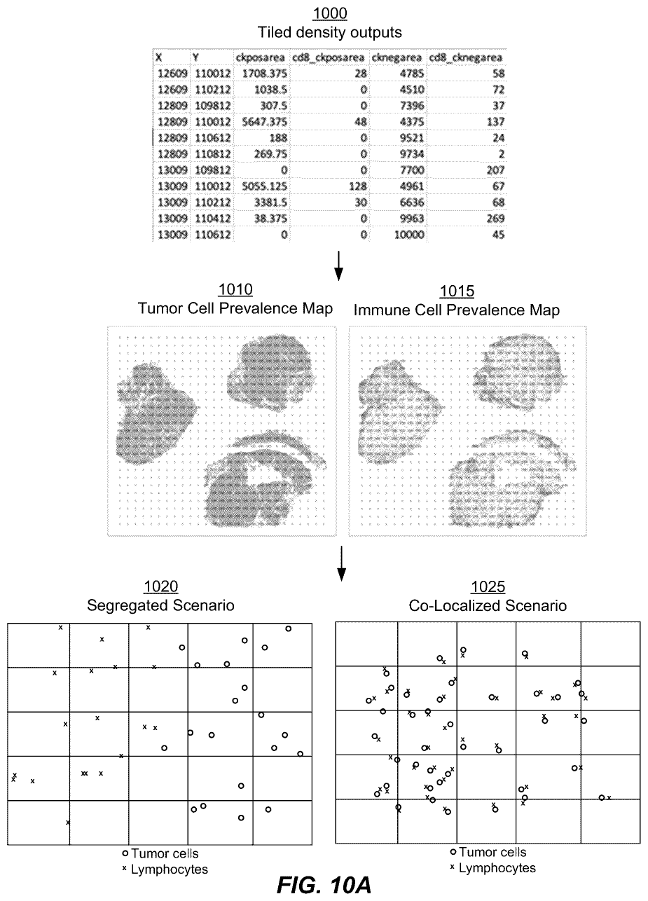

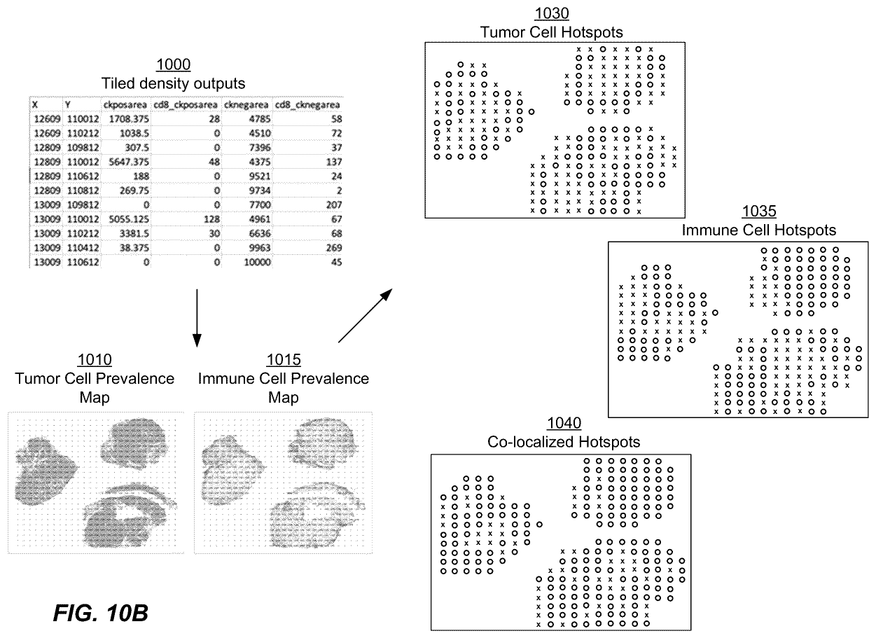

FIG. 10A depicts an application of an areal analysis framework 230. In particular, an areal analysis framework 230 was used to process a digital pathology image of a stained sample section. Densities of particular types of biological objects (e.g., tumor cells and T cells) were detected, as described above to produce biological object data, an example of which is shown in table 1000. The output biological object data includes, in certain embodiments, coordinates of individual tiles within the lattice formed by the image tiling module 112, and areas of the tile associated with each of the biological objects of interest. As an example, when the biological objects of interest include CD8+ T cells and CK+ or CK+ tumor cells, the output biological data includes areas of the tiles associated with CK+ tumor cells, the areas of the tiles associated with CK-tumor cells, the areas of the tiles associated with CK+ tumor cells and CD8+ T cells, and the areas of the tiles associated with CK− tumor cells and CD8+ T cells.

As described, a spatial lattice having a defined number of columns and a defined number of rows may be used to divide the digital pathology image into tiles. For each tile, a number or density of biological object depictions within the region may be identified, such as by using the density accounting techniques described herein. For each biological object type, the collection of region-specific biological object densities—the mapping of which tiles, at which locations, contain specific density values—may be defined as the biological object type's lattice data.

FIG. 10A illustrates a particular embodiment of lattice data 1010 for depictions of a second type of biological object—CK+ tumor cells—and lattice data 1015 for depictions of a first type of biological object—CD8+ T cells. Each of the lattice data is shown, for purposes of illustration, as being overlaid on a representation of the digital pathology image of the stained section. In some embodiments, each tile may be a spatial unit, and the center coordinates of the tiles may be extracted to form a spatial lattice. Lattice data may be defined to include, for each region in the lattice, a prevalence value defined to equal counts for the region divided by total counts across all regions. Thus, regions within which there are no biological objects of a given type will have a prevalence value of 0, while regions within which there is at least one biological object of a given type will have a positive non-zero prevalence value.

One or more prevalence maps may be created using the prevalence values. For example, for a CK/CD8 prevalence map, the area ratio of CK:CD8 (e.g., the ratio of the number of CK+ pixels to the number of CD8+ pixels) may be calculated for each tile. The area for each tile may be normalized by dividing by the sum of CK regions by the sum of CD8 regions across all tiles for the same slide, thereby mitigating the slide size effect. One or more spatial-distribution metrics may be derived from the prevalence map(s). The spatial-distribution metrics may represent, among others, the co-localization of two biological object types, such as CK+ tumor cells and CD8+ T cells, and/or the spatial distribution of one biological object type, such as CD8+ T cells in CK+ or CK-negative regions, respectively.

Identical amounts of biological objects (e.g., lymphocytes) in two different contexts (e.g., tumors) do not necessarily imply the characterization or degree of characterization (e.g., the same immune infiltration). Instead, how the biological object depictions of a first type are distributed in relation to biological object depictions of a second type may possibly indicate a functional state. Therefore, characterizing proximity of biological object depictions of the same and different types may reflect more information. The Morisita-Horn Index is an ecological measure of similarity (e.g., overlap) in biological or ecological systems. The Morisita-Horn index (MH) to characterize the bi-variate relationship or co-localization between two populations of biological object depictions (e.g., of two types) may be defined as:

$$MH = \frac{2 {\sum }_{i}^{n} {z}_{i}^{l} {z}_{i}^{t}}{{\sum }_{i}^{n} {( {z}_{i}^{l} )}^{2} + {\sum }_{i}^{n} {( {z}_{i}^{t} )}^{2}}$$

where zᵢ^{l}, zᵢ^{t} denotes the prevalence of biological object depictions of a first type and biological object depictions of a second type at the square grids i, respectively. In FIG. 10A, lattice data 1010 shows exemplary prevalence values zᵢ^{t} of depictions of a first type of biological object across grid points, and lattice data 1015 shows exemplary prevalence values zᵢ^{l} of depictions of a second type of biological object of the across grid points.

The Morisita-Horn Index is defined to be 0 when individual lattice regions do not include biological object depictions of both types (indicating that the distributions of different biological object types are spatially separated). For example, the Morisita-Horn Index would be 0 when considering the illustrative spatially separate distributions or segregated distributions shown in illustrative first scenario 1020. The Morisita-Horn Index is defined to be 1 when a distribution of a first biological object type across lattice regions matches (or is a scaled version of) a distribution of a second biological object type across lattice regions. For example, the Morisita-Horn Index would be close to 1 when considering the illustrative highly co-localized distributions shown in illustrative second scenario 1025.

In the example illustrated in FIG. 10A, the Morisita-Horn Index calculated using lattice data 1010 and lattice data 1015 was 0.47. The high Morisita-Horn Index value indicates that the depictions of biological objects of the first type and second type were highly co-localized.

Jaccard index (J) and Sorensen index (L) are similar and closely related to each other. They may be defined as:

$$J = \frac{{\sum }_{i}^{n} min ( {z}_{i}^{l} , {z}_{i}^{t} )}{{\sum }_{i}^{n} ( {z}_{i}^{l} + {z}_{i}^{t} ) - {\sum }_{i}^{n} min ( {z}_{i}^{l} , {z}_{i}^{t} )}$$

$$L = \frac{2 {\sum }_{i}^{n} min ( {z}_{i}^{l} , {z}_{i}^{t} )}{{\sum }_{i}^{n} ( {z}_{i}^{l} + {z}_{i}^{t} )}$$

where zᵢ^{l}, zᵢ^{t} denotes the prevalence of biological object depictions of a first type and biological object depictions of a second type at the square grids i, respectively, min(a, b) returns the minimum value between a and b. The Jaccard Index and Sørensen Index may be used to represent the spatial co-location of biological object types.

Another metric that may characterize a spatial distribution of biological object depictions is Moran's Index, which is a measure of spatial autocorrelation. Generally, Moran's Index is the correlation coefficient for the relationship between a first variable and a second variable at neighboring spatial units. The first variable may be defined as prevalence of depictions of biological objects of a first type and the second variable may be defined as prevalence of depictions of biological objects of a second type, so as to quantify the extent to which the two types of biological object depictions are interspersed in digital pathology images. A Moran's Index, I, may be defined as:

$$I = \frac{n}{{\sum }_{i}^{n} {\sum }_{j}^{n} {w}_{ij}} ( {{\sum }^{n}}_{i} {{\sum }^{n}}_{j} {w}_{ij} ( {x}_{i} ) ( {y}_{j} ) )$$

where xᵢ, yⱼ denotes the standardized prevalence of biological object depictions of the first type (e.g., lymphocytes) at areal unit i, and the standardized prevalence of biological object depictions of the second type (e.g., tumor cells) at areal unit j. The ωᵢⱼ is the binary weight for areal unit i and j, a weight is 1 if two units neighbor, and 0 otherwise, a first-order scheme may be used to define neighborhood structure. Moran's I may be derived separately for biological object depictions of different types of biological objects.

Moran's Index is defined to be equal to −1 when biological object depictions are perfectly dispersed across a lattice (and thus having a negative spatial autocorrelation); and to be 1 when biological object depictions are tightly clustered (and thus having a positive autocorrelation). Moran's Index is defined to be 0 when an object distribution matches a random distribution. The areal representation of particular biological object depiction types thus facilitates generating a grid that supports calculation of a Moran's Index for each biological object type. In embodiments in which two or more types of biological object depictions are being identified and tracked, a difference between the Moran's Index calculated for each of the two or more types of biological object depictions may provide an indication of colocation (e.g., with differences near zero indicating colocation) between those types of biological object depictions.

Geary's C, also known as Geary's contiguity ratio, is measure of spatial autocorrelation or an attempt to determine if adjacent observations of the same phenomenon are correlated. Geary's C is inversely related to Moran's I, but it is not identical. While Moran's I is a measure of global spatial autocorrelation, Geary's C is more sensitive to local spatial autocorrelation.

$$C = \frac{n - 1}{2 {\sum }_{i}^{n} {\sum }_{j}^{n} {w}_{ij}} \frac{{\sum }_{i}^{n} {\sum }_{j}^{n} {{w}_{ij} ( {z}_{i} - {z}_{j} )}^{2}}{{\sum }_{i}^{n} {( {z}_{i} - \overline{z} )}^{2}}$$

where zᵢ denotes the prevalence of either biological object depictions of a first type or a second type at the square grids i, ω_{i,j} is the same as defined aforementioned.

Another metric that may characterize a spatial distribution of biological object depictions is the Bhattacharyya coefficient (“B coefficient”), which is an approximate measure of an overlap between two statistical samples. In general, the B coefficient may be used to determine the relative closeness of the two statistical samples (e.g., biological objects or biological object types), such as the spatial co-location features of CK+ pixels and CD8+ pixels in CK+ tiles. It is used to measure the separability of classes in the classification.

Given probability distributions p and q over the same domain X (e.g., distributions of depictions of two types of biological objects within the same digital pathology image), the B coefficient is defined as

$$BC ( p , q ) = {\sum }_{x ∈ X} \sqrt{p ( x ) q ( x )}$$

where 0≤BC≤1 and 0≤D_{B}≤∞. Note that D_{B} does not obey the triangle inequality, but the Hellinger distance, \sqrt{1−BC(p, q)} does obey the triangle inequality. The B coefficient increases with the number of partitions in the domain that have members from both samples (e.g., with the number of tiles in the digital pathology image that have depictions or suitable density of two or more types of biological object depictions). The B coefficient is therefore larger still with each partition in the domain that has a significant overlap of the samples, e.g., with each partition that contains a large number of the members of the two samples. The choice of the number of partitions is variable and may be customized to the number of members in each sample. To maintain accuracy, care is taken to avoid selecting too few partitions and overestimating the overlap region as well as taking too many partitions and creating partitions with no members despite being in a densely populated sample space. The B coefficient will be 0 is there is no overlap at all between the two samples of biological object depictions.

Lattice data 1010 and lattice data 1015 may be further processed to generate hotspot data 1030 corresponding to detected depictions of a first type of biological object and hotspot data 1035 corresponding to detected depictions of a second type of biological object, respectively. In FIG. 10B, hotspot data 1030 and hotspot data 1035 indicate the regions that were determined to be hotspots for the respective types of detected depictions of biological objects. The regions that were detected as hotspots are shown as circles and the regions that were determined not to be hotspots as an ‘x.’ Hotspot data 1030, 1035 was defined for each region associated with a non-zero object count. Hotspot data 1030, 1035 may also include binary values that indicate whether a given region was identified as being a hotspot or not. In addition to hotspot data and analysis, coldspot data and analysis may be conducted.

With respect to depictions of biological objects, hotspot data 1030, 1035 may be generated for each biological object type by determining a Getis-Ord local statistic for each region associated with a non-zero object count for the biological object type. Getis-Ord hotspot/coldspot analysis may be used to identify statistically significant hotspots/coldspots of tumor cells or lymphocytes, where hotspots are the areal units with a statistically significantly high value of prevalence of depictions of biological objects compared to the neighboring areal units and coldspots are the areal units with a statistically significantly low value of prevalence of depictions of biological objects compared to neighboring areal units. The value and determination what makes a hotspot/coldspot region compared the neighboring regions may be selected according to user preference, and, in particular may be selected according to a rules-based approach or learned model. For example, the number and/or type of biological object depictions detected, the absolute number of depictions, and other factors may be considered. The Getis-Ord local statistic is a z-score and may be defined, for a square grid i, as:

$${G}_{i}^{*} = \frac{{\sum }_{j = 1}^{n} {ω}_{i , j} {z}_{j} - \overline{z} {\sum }_{j = 1}^{n} {ω}_{i , j}}{S \sqrt{\frac{n {\sum }_{j = 1}^{n} {ω}_{i , j}^{2} - {( {\sum }_{j = 1}^{n} {ω}_{i , j} )}^{2}}{n - 1}}}$$

where i represents an individual region (specific row-column combination) in the lattice, n is the number of row and column combinations (i.e., number of regions) in the lattice, ω_{i,j} is the spatial weight between i and j, and zⱼ is the prevalence of biological object depictions of a given type in a region, z̅ is the average object prevalence of the given type across regions, and:

$$S = \sqrt{\frac{{\sum }_{j = 1}^{n} {z}_{j}^{2}}{n} - {( \overline{z} )}^{2}}$$

The Getis-Ord local statistics may be transformed to binary values by determining whether each statistic exceeds a threshold. For example, a threshold may be set to 0.16. The threshold may be selected according to user preference, and in particular may be set according to rule-based or machine-learned approaches.

Another metric that may characterize a spatial distribution of biological object depictions is a Colocation Quotient (CLQ), which is a ratio of ratios and may be used to measure the local density to the global density of a specific type of biological object. The CLQ measures the co-occurrence or avoidance of biological object pairs. Specifically, the CLQ method may look at the local density of a target biological object type at a fixed radius from each occurrence of the sample belonging to a reference biological object. The CLQ may be defined as:

$${LCLQ}_{{A}_{i} \to B} = \frac{{N}_{{A}_{i} \to B}}{{N}_{b} ( N - 1 )}$$

$${N}_{{A}_{i} \to B} = \sum \frac{{w}_{ij} {δ}_{ij}}{\sum {w}_{ij}}$$

$${CLQ}_{A \to B} = \frac{{\sum }_{i = 1}^{{N}_{A}} {LCLQ}_{{A}_{i} \to B}}{{N}_{A}}$$

where CLQ_{A→B} is the global CLQ for cell type A, LCLQ_{A→B} is the local CLQ for cell type A, N is the total number of cells in the image, δᵢⱼ is the Kroenecker delta indicating whether cell j is a type B cell; wᵢⱼ is 1/N for the non-weighted version, and Gaussian distance decay kernel for the weighted version.

For example, the local density may be calculated as a portion of cell type B in the neighborhood constructed by a certain radius, centered around cell type A. The global density may be the proportion of cell type B in the whole slide image. The CLQ may be greater than 1 when the density of cell type B within the neighborhood of cell type A is more than the global density of cell type B. The CLQ may be less than 1 when the neighborhood of cell type A contains many other cell types other than cell type B. A CLQ value of 1 may mean that there is no spatial relationships between cell type A and cell type B.

Additionally, the CLQ method may rely on continuous summary statistics. Thus, the CLQ method may have the ability to go beyond the three immunophenotype categories (e.g., desert, excluded, and inflamed) as described herein and may highlight immunophenotypes or cases that lie in the border of the immunophenotype classes.

A logical AND function may be used to identify the regions that are identified as being a hotspot for more than one type of depictions of biological objects. For example, co-localized hotspot data 1040 indicates the regions that were identified as being a hotspot for two types of biological object depictions (shown as circles symbols). A high ratio of a number of regions identified as being a co-localized hotspot relative to a number of hotspot regions identified for a given object type (e.g., for tumor-cell objects) may indicate that biological object depictions of the given type share spatial characteristics with the other object type. Meanwhile, a low ratio at or near zero may be consistent with spatial segregation of biological objects of the different types.

Once the spatial-distribution metrics have been generated, the spatial-distribution metrics, density values, and other generated data may be used to assign an immunophenotype to the sample. As described herein, the designation of the immunophenotype may be provided by a machine-learned model, trained in a supervising training process wherein labeled digital pathology images are provided along with their spatial-distribution metrics. Through the training process, the digital pathology image processing system 110 or one or more modules thereof, including the immunophenotyping module 116, may learn to categorize digital pathology images, and their corresponding samples, into selected immunophenotyping groups.

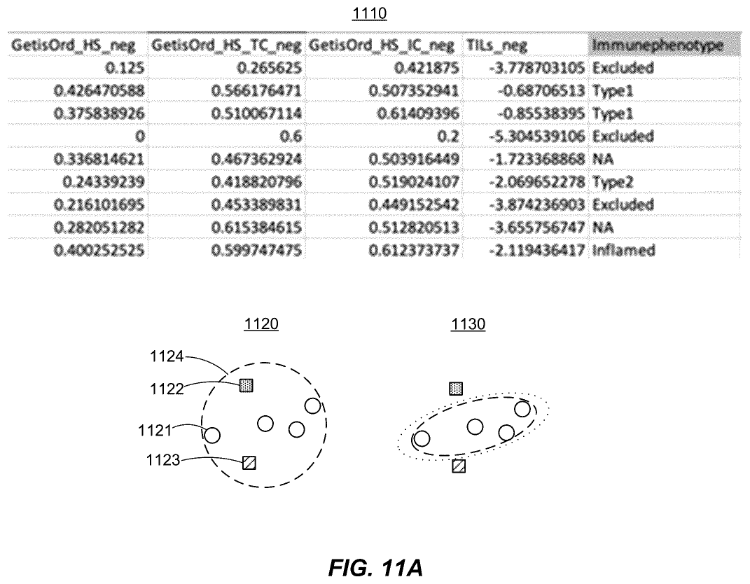

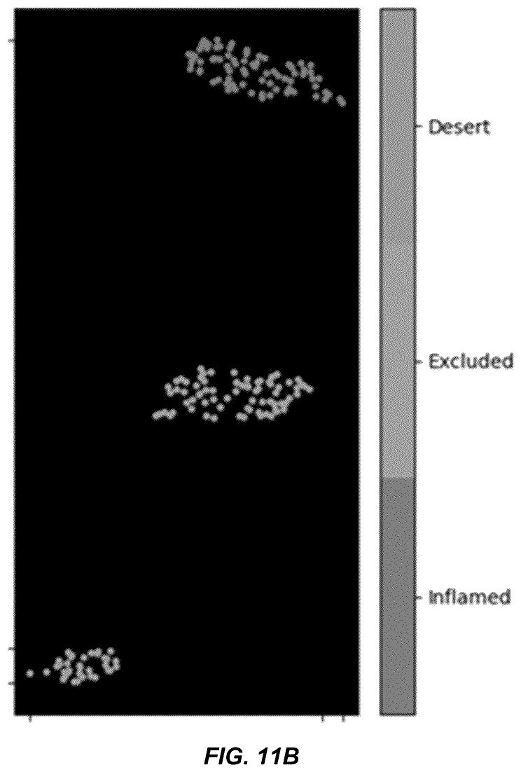

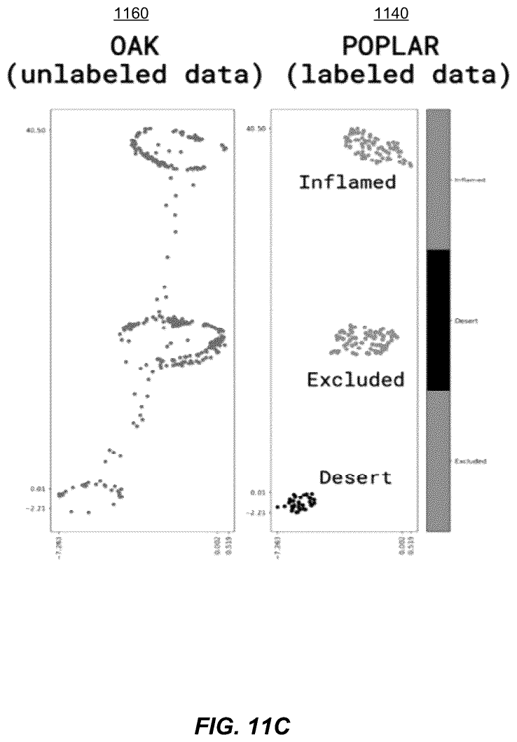

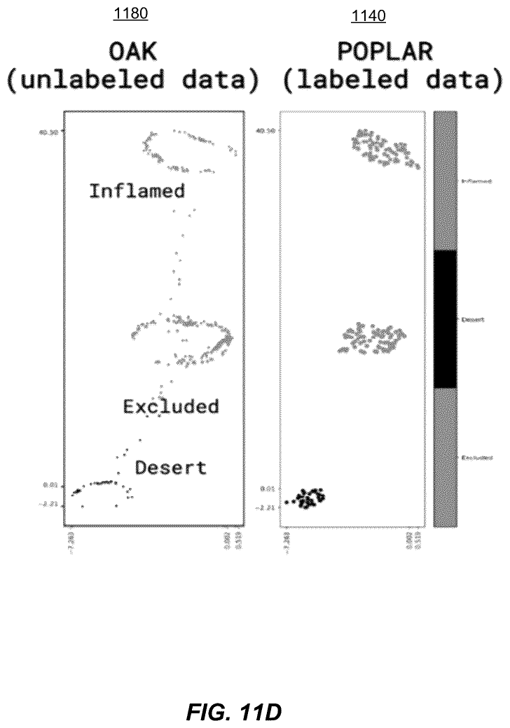

FIG. 11A illustrates one visualization of the training and use of the machine-learned models making up one embodiment of an immunophenotyping module 116. The data generated by the various components of the digital pathology image processing system 110 may be collected into a training data set 1110. The training set includes values for the various spatial-distribution metrics discussed herein. For training purposes, the training data set 1110 also includes an immunophenotype that has been assigned to the samples, such as manually by a pathologist. Each digital pathology image may be projected into a multi-variable space, with an axis for each of the spatial-distribution metrics and/or variations or derivation therefrom. With the supplied labels, the machine-learned model may be trained to identify clusters of the digital pathology images (and corresponding samples) within the multi-variable space. In this formulation, the task of labeling a previously unseen data point may be approximated by determining to which cluster the new data point belongs.

FIG. 11A further illustrates challenges of identifying the proper mechanism for identifying the clustering criteria. Plot 1120 shows data points for several digital pathology images, plotted on a two-dimensional Cartesian grid. Circular points 1121 designate a first type of label, squares points designate two different labels that are each distinct from the first type of label. The label may equate to an immunophenotype. A first attempt to group the points may involve, for example, a Euclidean nearest neighbor approach. In such an approach, all points within a certain radius 1124 may be labeled with the target label type. While in this example this neighborhood indeed captures all of the points 1121 associated with the first type of label, it also captures the two imposter data points 1122 and 1123 (illustrated as squares). To accurately capture only points associated with the first label type within the neighborhood, additional measures of similarity may be used. In one example, this may include the consideration of additional metrics (e.g., adding additional axes of similarity). As such, in plot 1130, a hyperplane through the multi-variable space represented by the data (e.g., in training data set 1110), may effectively differentiate the target points 1121 from the imposter data points 1122 and 1123. Moreover, additional distance metrics besides the Euclidean distance metric may be used to define the nearest neighbors and the resulting clusters.

FIG. 11B illustrates plot 1140, which shows the idealized result, especially in comparison to the plot 900 shown in FIG. 9. In plot 1140, neat groupings of the data have been identified, differentiating between, in this example, desert, excluded, and inflamed immunophenotypes based on the input data. The relationship between the spatial-distance metrics used to create these groupings and the groupings themselves may more clearly be seen than using mere density measurements alone (as shown in plot 900).

A machine-learning model may be trained to process a digital pathology image, e.g., of a biopsy section from a subject, to predict an assessment of a condition of the subject from the digital pathology image. As an example, using the techniques described herein, the digital pathology image processing system may generate a variety of spatial-distribution metrics and predict an immunophenotype for the digital pathology image. From this input, a regression machine-learning model may be trained predict, for example, suspected patient outcomes, assessments of related patient condition factors, availability or eligibility for selected treatments, and other related recommendations.

A biopsy may be collected from each of multiple subjects having the condition. The sample may be fixed, embedded, sliced, stained, and imaged according to the subject matter disclosed herein. Depictions and density of specified types of biological objects, e.g., tumor cells and lymphocytes, may be detected. The digital pathology image processing system may use a trained set of machine-learned models to process images to quantify the density of biological objects of interest. For each subject of the multiple subjects, a label may be generated so as to indicate whether the condition exhibited specified features and/or indicate certain secondary labels (e.g., immunophenotype) applied by the digital pathology image processing system. In the context of predicting an overall assessment of the condition of the subject, labels such as immunophenotype are considered secondary as they may inform the overall assessment.

For each subject, an input vector may be defined to include a set of spatial-distribution metrics. The set of spatial-distribution metrics may include a selection of the metrics described herein. The set of spatial-distribution metrics may capture the co-location of one or more biological object types, e.g., CD8+ T cells, in CK+ or CK-negative tiles, the spatial distribution of CK+ tumor cells in CK+ tiles or CK-negative tiles, or both. As an example, metrics to be included in the input vector may include:
Intra-tumor lymphocyte ratio;
Bhattacharyya coefficient;
Morisita-Horn Index;
Jaccard Index;
Sørensen Index;
B coefficient;
Moran's Index;
Geary's C;
a CD8-CK area ratio;
The ratio of co-localized spots (e.g., hotspots, coldspots, non-significant spots) for the type of biological object depictions over the number of spots (e.g., hotspots, coldspots, non-significant spots) for a first type of the biological object depictions, with spots (e.g., hotspots, coldspots, non-significant spots) defined using Getis-Ord local statistics; and/or
Features obtained by variogram fitting of two types of biological object depictions (e.g., tumor cells and lymphocytes).

The metrics chosen may correspond to multiple frameworks (e.g., areal-process analysis framework). For each subject, a label may be defined to indicate secondary determinations, such as object density metrics and/or assigned immunophenotype. A machine-learned model, including but not limited to a logistic-regression model, may be trained and tested with the paired input data and labels, using repeated nested cross-validation. As an example, for each of 5 data folds, the model may be trained on the remaining 4 folds and tested on the remaining fold to calculate an area under an ROC.

In embodiments with limited sample size, adaptable techniques to evaluate model performance may be used. As a non-limiting example, a nested Monte Carlo Cross Validation (nMCCV) may be used to evaluate the model performance. The same enrichment procedure may be repeated B times by randomly splitting with the same proportion between training, validation and test sets, to produce an ensemble of score function and threshold {(Ŝ_{b}, \hat{q}_{b})}_{b=1}^{B}. For the i-th subject, the ensembled responder status may be evaluated by averaging, among the repetitions where i is randomized to test set, the membership of responder group for i, and thresholding by 0.5. Hazard ratio or Odds ratio together with a 95% confidence interval and p-value may be calculated on the aggregated test subjects.

In some embodiments, clustering of data points differentiating tumor immunophenotypes may be used to learn one or more spatial-distribution metrics or tumor immunophenotypes of unlabeled data. Data labeled with tumor immunophenotypes may be projected onto a space to spatially separate the labeled data into clusters having corresponding spatial-distribution metrics. In some embodiments, the spatial separation of inflamed, excluded, and desert immunophenotypes may be used to identify clusters of data points. For example, as shown in FIG. 11C, the labeled data in plot 1140 (shown against a white background in FIG. 11C) may be co-embedded into the same space as unlabeled data in plot 1160. The learned spatial separation of clusters of immunophenotypes from the data in plot 1140 may be used as a measure of distance between the unlabeled data in plot 1160. In some embodiments, the biological sample(s) in the unlabeled data may be assigned immunophenotypes (e.g., desert, excluded, or inflamed) based on the distances in the space from the centroids of the clusters (one for each immunophenotype) of the labeled data (in plot 1140) to the unlabeled data (plot 1160). The tumor immunophenotype of the biological sample(s) corresponding to one or more unlabeled data points may be determined based on the minimum distance.

In some embodiments, a cluster-matching process (e.g., K-means clustering) may be used to match one or more data points (one or more spatial-distribution metrics) in the unlabeled data (in plot 1160) to a cluster of data points in the labeled data (in plot 1140). The labeled data may be labeled with a corresponding immunophenotype. The biological sample(s) corresponding to one or more unlabeled data points may be assigned immunophenotype labels (e.g., desert, excluded, or inflamed) based on the matched clusters, as shown in plot 1180 of FIG. 11D. In some embodiments, therapy response information may be overlaid with the clusters in the space, and a recommended therapy may be determined based on the clusters. In certain embodiments, each unlabeled data point may be projected into a space trained on a labeled data set, and the immunophenotype label for each unlabeled data point may be assigned based on a shortest distance from a centroid of each immunophenotyping cluster from the labeled data set (the most likely immunophenotype class).

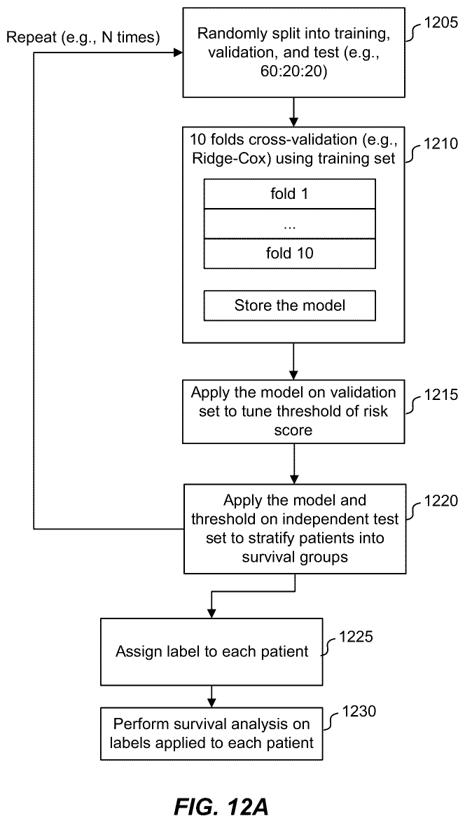

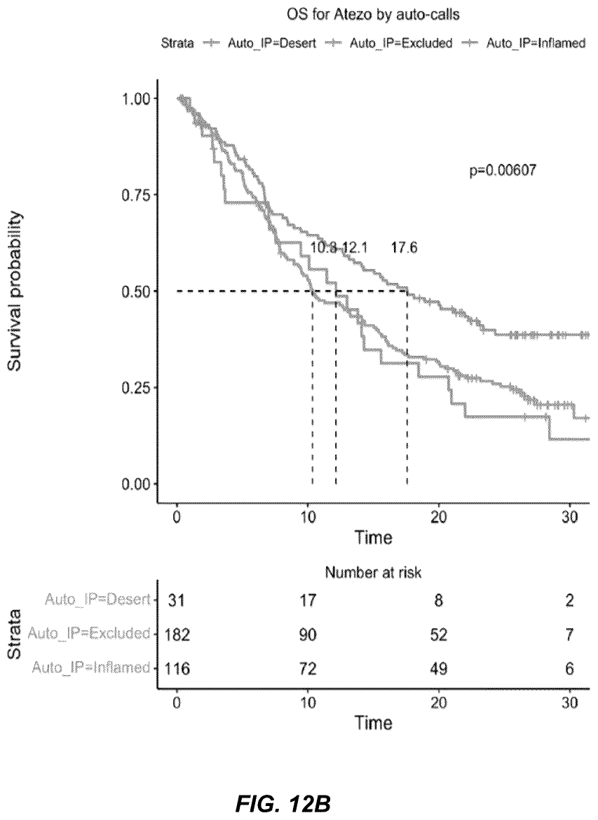

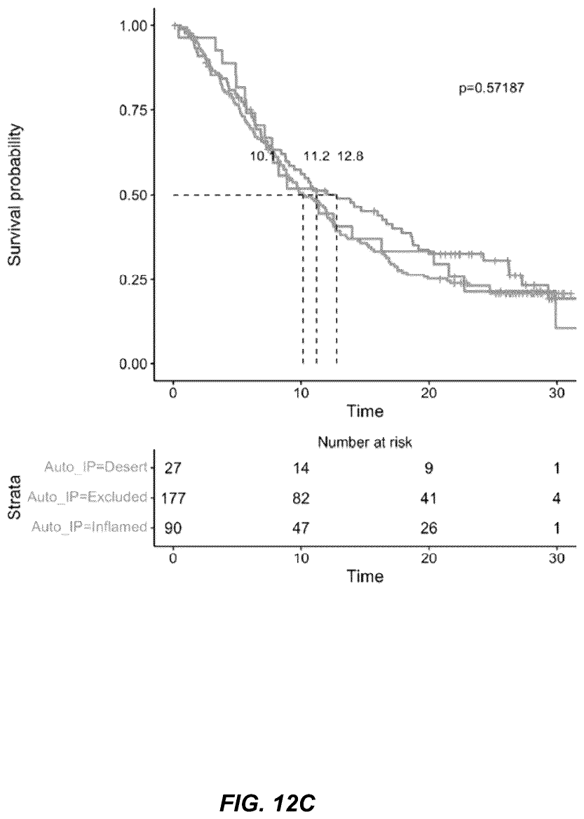

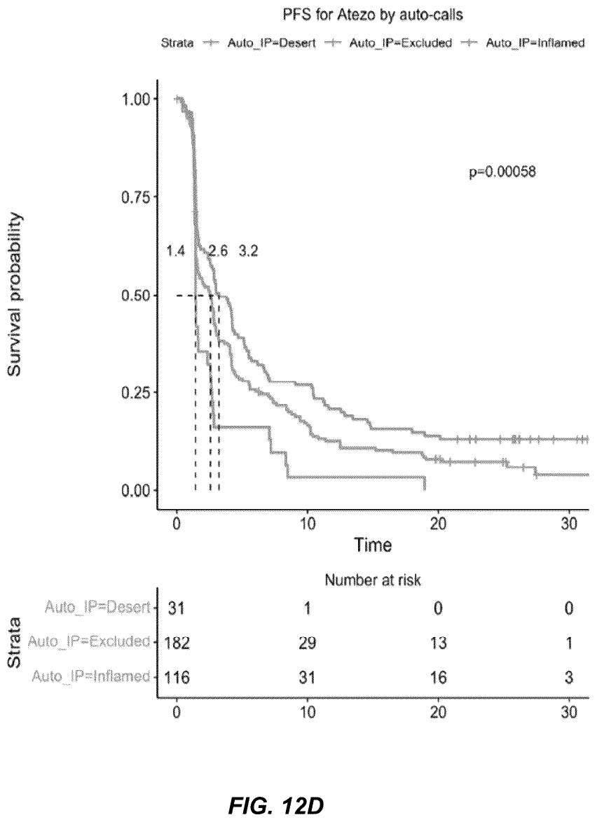

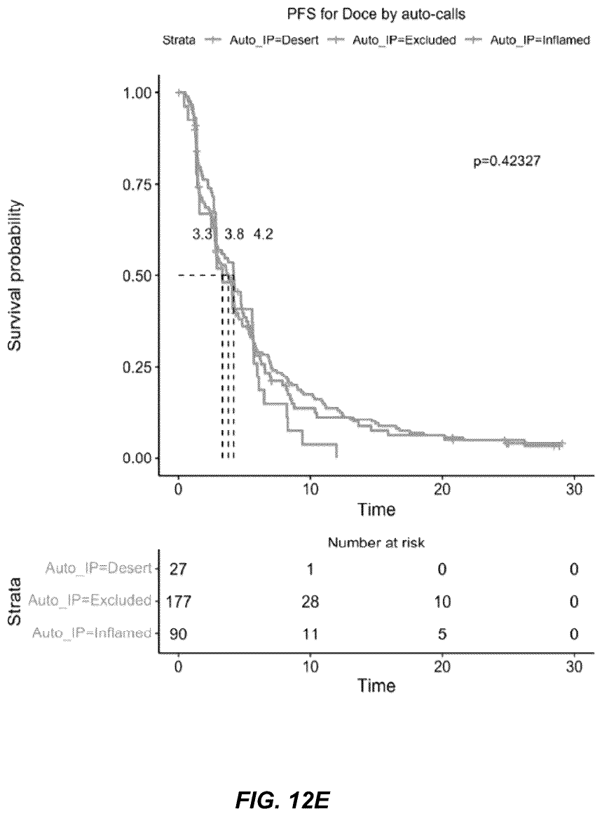

The overall workflow for predictive analysis is summarized in the flowchart of FIG. 12A. More specifically, in order to assign each subject in the study cohort a label, a nested Monte Carlo Cross-Validation (nMCCV) modeling strategy may be used to overcome overfitting.

Specifically, for each subject, at block 1205, a data set may be split into training, validation, and test data portions in 60:20:20 proportions. At block 1210, 10-fold cross-validation Ridge-Cox (L2 regularized Cox model) may be performed using the training set to produce 10 models (having a same model architecture). A particular model across the 10 produced models may be selected based on the 10-fold training data and stored. At block 1215, the particular model may then be applied on the validation set to tune a specified variable. For example, the variable may identify a threshold for a risk score. At block 1220, the threshold and particular model may then be applied to the independent test set to generate a vote for the subject predicting whether the subject is stratified into a longer or shorter survival (e.g., overall survival or progression-free survival) group. The data splitting, training, cut-off identification and vote generation (blocks 1205-1220) may be repeated N (e.g., =1000) times. At block 1225, the subject is then assigned to one of a longer survival group or a shorter survival group based on the votes. For example, the step at block 1225 may include assigning a subject to a longer survival group or shorter survival group by determining which group was associated with the majority of votes. At block 1230, a survival analysis may then be performed of the longer/shorter survival group subjects. It will be appreciated that similar procedures to apply a wide variety of labels to data, based on the outcomes of interest, may be applied any suitable clinical evaluation or eligibility study.

FIGS. 12B and 12C illustrate overall survival for whole slide images classified according to desert, excluded, and inflamed immunophenotypes, and FIGS. 12D and 12E illustrate progression-free survival for whole slide images classified according to desert, excluded, and inflamed immunophenotypes. The plots show the disclosed approach may yield a clear separation of classified immunophenotypes for a group receiving a certain treatment (e.g., atezolizumab) compared to a group receiving a different treatment (e.g., docetaxel). Thus, atezolizumab improved overall survival and progression-free survival compared to docetaxel.

The comprehensive model based on spatial statistics and spatial-distribution metrics used in the analysis of this example empowers an analytical pipeline that generates system-level knowledge of, in this case, immunophenotype decided based on intra-tumoral density by modeling histopathology images as spatial data assisted through pixel-based segmentation. This effect is not limited to particular treatment evaluations, but may be applied in many scenarios where the necessary ground truth data is available. Using spatial statistics to characterize histopathology images, and other digital pathology images, may be useful in the clinical setting to predict treatment outcomes and to thus inform treatment selection.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

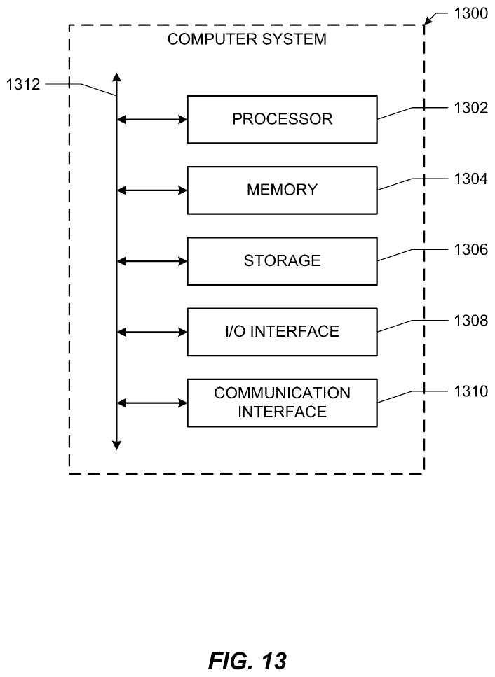

FIG. 13 illustrates an example computer system 1300. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302. Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular embodiments, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Various Embodiments of the Invention May Include:
1. A method comprising:
accessing, by a digital pathology image processing system, a digital pathology image that depicts a section of a biological sample, wherein the digital pathology image comprises regions displaying reactivity to two or more stains;
subdividing, by the digital pathology image processing system, the digital pathology image into a plurality of tiles;
for each of the plurality of tiles, calculating, by the digital pathology image processing system, a local-density measurement of each of plurality of biological object types;
generating, by the digital pathology image processing system, one or more spatial-distribution metrics for the plurality of biological object types in the digital pathology image based at least in part on the calculated local-density measurements; and
determining, by the digital pathology image processing system, a tumor immunophenotype of the digital pathology image based at least in part on the local-density measurements or the one or more spatial-distribution metrics.
2. The method of claim 1, wherein each of the local-density measurements comprises a representation of an absolute or relative quantity, an area, or a density.
3. The method of claim 1 or 2, wherein the plurality of biological object types comprise tumor cells and immune cells, the tumor immunophenotype comprises:
desert when, for the plurality of tiles, the local-density measurement of the immune cells is less than an immune-cell-density threshold;
excluded when, for one or more of the plurality of tiles, the local-density measurement of the tumor cells is less than a tumor-cell-density threshold and the local-density measurement of the immune cells is greater than or equal to the immune-cell-density threshold; or
inflamed when, for one or more of the plurality of tiles, the local-density measurement of the tumor cells is greater than or equal to the tumor-cell-density threshold and the local-density measurement of the immune cells is greater than or equal to the immune-cell-density threshold.
4. The method of any of claims 1-3, wherein the one or more spatial-distribution metrics characterize a degree to which a first biological object type is depicted as being interspersed with a second biological object type.
5. The method of any of claims 1-4, wherein the one or more spatial-distribution metrics comprise:
a Jaccard index;
a Sørensen index;
a Bhattacharyya coefficient;
a Moran's index;
a Geary's contiguity ratio;
a Morisita-Horn index; or
a metric defined based on a hotspot/coldspot analysis.
6. The method of any of claims 1-5, wherein the plurality of biological object types comprise tumor cells and immune cells, the tumor immunophenotype comprises:
excluded when, for one or more of the plurality of tiles, the one or more spatial-distribution metrics indicate a spatial separation of the tumor cells and the immune cells; or
inflamed when, for one or more of the plurality of tiles, the one or more spatial-distribution metrics indicate a co-localization of the tumor cells and the immune cells.
7. The method of any of claims 1-6, wherein calculating the local-density measurement of each of the plurality of biological object types comprises:
for each of the plurality of tiles:
segmenting the tile into a plurality of regions according to the two or more stains, wherein each of the biological object types is reactive to one of the stains;
classifying each of the regions according to reactivity to the stains; and
calculating the local-density measurement of each of the plurality of biological object types located within the tile based on a number of the regions of the tile classified with each of the two or more stains.
8. The method of claim 7, wherein each of the regions of the tile is determined based on a stain intensity value of the region, the stain intensity value being based on the reactivity of each of the plurality of biological object types to one of the two or more stains.
9. The method of claim 7 or 8, wherein the regions of the tiles are determined as tumor-associated regions and non-tumor-associated regions.
10. The method of claim 9, wherein each of the tumor-associated regions and non-tumor-associated regions are determined as immune-cell-associated regions and non-immune-cell-associated regions.
11. The method of any of claims 1-10, wherein determining the tumor immunophenotype of the image comprises:
projecting a representation of the digital pathology image into a feature space with axes based on the one or more spatial-distribution metrics; and
determining the tumor immunophenotype of the image based on a position of the digital pathology image within the feature space.
12. The method of claim 11, wherein determining the tumor immunophenotype of the image is further based on a proximity of the position of the digital pathology image within the feature space to a position of one or more other digital pathology image representations with assigned tumor immunophenotypes.
13. The method of any of claims 1-12, wherein the plurality of biological object types comprise cytokeratin and cytotoxic structures.
14. The method of any of claims 1-13, further comprising:
identifying one or more tumor regions in the digital pathology image comprising:
providing a user interface for display comprising the digital pathology image and one or more interactive elements; and
receiving a selection of the one or more tumor regions through interaction with the one or more interactive elements.
15. The method of any of claims 1-14, further comprising:
generating, based at least in part on the tumor immunophenotype of the image and the one or more spatial-distribution metrics, a result that corresponds to an assessment of a medical condition of a subject, including a prognosis for outcomes of the medical condition; and
generating a display including an indication of the assessment of the medical condition of the subject and the prognosis.
16. The method of claim 15, wherein determining the tumor immunophenotype of the image and generating the one or more spatial-distribution metrics use a trained machine-learned model, the trained machine-learned model having been trained using a set of training elements, each of the set of training elements corresponding to another subject having a similar medical condition and for which an outcome of the medical condition is known.
17. The method of any of claims 1-16, further comprising:
generating, based at least in part on the one or more spatial-distribution metrics, a result that corresponds to a prediction regarding a degree to which a given treatment that modulates immunological response will effectively treat a medical condition of a subject;
determining that the subject is eligible for a clinical trial based on the result; and
generating a display including an indication that the subject is eligible for the clinical trial.
18. A digital pathology image processing system comprising:
one or more data processors; and
a non-transitory computer readable storage medium communicatively coupled to the one or more data processors, and including instructions which, when executed by the one or more data processors, cause the one or more data processors to perform one or more operations comprising:
accessing a digital pathology image that depicts a section of a biological sample, wherein the digital pathology image comprises regions displaying a reaction to two or more stains;
subdividing the digital pathology image into a plurality of tiles;
for each of the plurality of tiles, calculating a local-density measurement of each of plurality of biological object types identified within the tile;
generating one or more spatial-distribution metrics for the plurality of biological object types in the digital pathology image based at least in part on the calculated local-density measurements; and
determining a tumor immunophenotype of the digital pathology image based at least in part on the local-density measurements and the one or more spatial-distribution metrics.
19. The digital pathology image processing system of claim 18, wherein each of the local-density measurements comprises a representation of an absolute or relative quantity, an area, or a density.
20. The digital pathology image processing system of claim 18 or 19, wherein the plurality of biological object types comprise tumor cells and immune cells, the tumor immunophenotype comprises:
desert when, for the plurality of tiles, the local-density measurement of the immune cells is less than an immune-cell-density threshold;
excluded when, for one or more of the plurality of tiles, the local-density measurement of the tumor cells is less than a tumor-cell-density threshold and the local-density measurement of the immune cells is greater than or equal to the immune-cell-density threshold; or
inflamed when, for one or more of the plurality of tiles, the local-density measurement of the tumor cells is greater than or equal to the tumor-cell-density threshold and the local-density measurement of the immune cells is greater than or equal to the immune-cell-density threshold.
21. The digital pathology image processing system of any of claims 18-20, wherein the one or more spatial-distribution metrics characterize a degree to which a first biological object type is depicted as being interspersed with a second biological object type.
22. The digital pathology image processing system of any of claims 18-21, wherein the one or more spatial-distribution metrics comprise:
a Jaccard index;
a Sørensen index;
a Bhattacharyya coefficient;
a Moran's index;
a Geary's contiguity ratio;
a Morisita-Horn index; or
a metric defined based on a hotspot/coldspot analysis.
23. The digital pathology image processing system of any of claims 18-22, wherein the plurality of biological object types comprise tumor cells and immune cells, the tumor immunophenotype comprises:
excluded when, for one or more of the plurality of tiles, the one or more spatial-distribution metrics indicate a spatial separation of the tumor cells and the immune cells; or
inflamed when, for one or more of the plurality of tiles, the one or more spatial-distribution metrics indicate a co-localization of the tumor cells and the immune cells.
24. The digital pathology image processing system of any of claims 18-23, wherein calculating the local-density measurement of each of the plurality of biological object types comprises:
for each of the plurality of tiles:
segmenting the tile into a plurality of regions according to the two or more stains, wherein each of the biological object types is reactive to one of the stains;
classifying each of the regions according to reactivity to the stains; and
calculating the local-density measurement of each of the plurality of biological object types located within the tile based on a number of the regions of the tile classified with each of the two or more stains.
25. The digital pathology image processing system of claim 24, wherein each of the regions of the tile is determined based on a stain intensity value of the region, the stain intensity value being based on the reactivity of each of the plurality of biological object types to one of the two or more stains.
26. The digital pathology image processing system of claim 24 or 25, wherein the regions of the tiles are determined as tumor-associated regions and non-tumor-associated regions.
27. The digital pathology image processing system of claim 26, wherein each of the tumor-associated regions and non-tumor-associated regions are determined as immune-cell-associated regions and non-immune-cell-associated regions.
28. The digital pathology image processing system of any of claims 18-27, wherein determining the tumor immunophenotype of the image comprises:
projecting a representation of the digital pathology image into a feature space with axes based on the one or more spatial-distribution metrics; and
determining the tumor immunophenotype of the image based on a position of the digital pathology image within the feature space.
29. The digital pathology image processing system of claim 28, wherein determining the tumor immunophenotype of the image is further based on a proximity of the position of the digital pathology image within the feature space to a position of one or more other digital pathology image representations with assigned tumor immunophenotypes.
30. The digital pathology image processing system of any of claims 18-29, wherein the plurality of biological object types comprise cytokeratin and cytotoxic structures.
31. The digital pathology image processing system of any of claims 18-30, further comprising:
identifying one or more tumor regions in the digital pathology image comprising:
providing a user interface for display comprising the digital pathology image and one or more interactive elements; and
receiving a selection of the one or more tumor regions through interaction with the one or more interactive elements.
32. The digital pathology image processing system of any of claims 18-31, further comprising:
generating, based at least in part on the tumor immunophenotype of the image and the one or more spatial-distribution metrics, a result that corresponds to an assessment of a medical condition of a subject, including a prognosis for outcomes of the medical condition; and
generating a display including an indication of the assessment of the medical condition of the subject and the prognosis.
33. The digital pathology image processing system of claim 32, wherein determining the tumor immunophenotype of the image and generating the one or more spatial-distribution metrics use a trained machine-learned model, the trained machine-learned model having been trained using a set of training elements, each of the set of training elements corresponding to another subject having a similar medical condition and for which an outcome of the medical condition is known.
34. The digital pathology image processing system of any of claims 18-33, further comprising:
generating, based at least in part on the one or more spatial-distribution metrics, a result that corresponds to a prediction regarding a degree to which a given treatment that modulates immunological response will effectively treat a medical condition of a subject;
determining that the subject is eligible for a clinical trial based on the result; and
generating a display including an indication that the subject is eligible for the clinical trial.
35. A non-transitory computer-readable medium comprising instructions that, when executed by one or more data processors of one or more computing devices, cause the one or more processors to:
receive a digital pathology image that depicts a section of a biological sample, wherein the digital pathology image comprises regions displaying a reaction to two or more stains;
segment the digital pathology image into a plurality of tiles;
for each of the plurality of tiles, calculate a local-density measurement of each of plurality of biological object types identified within the tile;
generate one or more spatial-distribution metrics for the plurality of biological object types in the digital pathology image based at least in part on the calculated local-density measurements; and
determine a tumor immunophenotype of the digital pathology image based at least in part on the local-density measurements or the one or more spatial-distribution metrics.
36. The method of claim 35, wherein each of the local-density measurements comprises a representation of an absolute or relative quantity, an area, or a density.
37. The method of claim 35 or 36, wherein the plurality of biological object types comprise tumor cells and immune cells, the tumor immunophenotype comprises:
desert when, for the plurality of tiles, the local-density measurement of the immune cells is less than an immune-cell-density threshold;
excluded when, for one or more of the plurality of tiles, the local-density measurement of the tumor cells is less than a tumor-cell-density threshold and the local-density measurement of the immune cells is greater than or equal to the immune-cell-density threshold; or
inflamed when, for one or more of the plurality of tiles, the local-density measurement of the tumor cells is greater than or equal to the tumor-cell-density threshold and the local-density measurement of the immune cells is greater than or equal to the immune-cell-density threshold.
38. The method of any of claims 35-37, wherein the one or more spatial-distribution metrics characterize a degree to which a first biological object type is depicted as being interspersed with a second biological object type.
39. The method of any of claims 35-38, wherein the one or more spatial-distribution metrics comprise:
a Jaccard index;
a Sørensen index;
a Bhattacharyya coefficient;
a Moran's index;
a Geary's contiguity ratio;
a Morisita-Horn index; or
a metric defined based on a hotspot/coldspot analysis.
40. The method of any of claims 35-39, wherein the plurality of biological object types comprise tumor cells and immune cells, the tumor immunophenotype comprises:
excluded when, for one or more of the plurality of tiles, the one or more spatial-distribution metrics indicate a spatial separation of the tumor cells and the immune cells; or
inflamed when, for one or more of the plurality of tiles, the one or more spatial-distribution metrics indicate a co-localization of the tumor cells and the immune cells.
41. The method of any of claims 35-40, wherein calculating the local-density measurement of each of the plurality of biological object types comprises:
for each of the plurality of tiles:
segmenting the tile into a plurality of regions according to the two or more stains, wherein each of the biological object types is reactive to one of the stains;
classifying each of the regions according to reactivity to the stains; and
calculating the local-density measurement of each of the plurality of biological object types located within the tile based on a number of the regions of the tile classified with each of the two or more stains.
42. The method of claim 41, wherein each of the regions of the tile is determined based on a stain intensity value of the region, the stain intensity value being based on the reactivity of each of the plurality of biological object types to one of the two or more stains.
43. The method of claim 41 or 42, wherein the regions of the tiles are determined as tumor-associated regions and non-tumor-associated regions.
44. The method of claim 43, wherein each of the tumor-associated regions and non-tumor-associated regions are determined as immune-cell-associated regions and non-immune-cell-associated regions.
45. The method of any of claims 35-44, wherein determining the tumor immunophenotype of the image comprises:
projecting a representation of the digital pathology image into a feature space with axes based on the one or more spatial-distribution metrics; and
determining the tumor immunophenotype of the image based on a position of the digital pathology image within the feature space.
46. The method of claim 45, wherein determining the tumor immunophenotype of the image is further based on a proximity of the position of the digital pathology image within the feature space to a position of one or more other digital pathology image representations with assigned tumor immunophenotypes.
47. The method of any of claims 35-46, wherein the plurality of biological object types comprise cytokeratin and cytotoxic structures.
48. The method of any of claims 35-47, further comprising:
identifying one or more tumor regions in the digital pathology image comprising:
providing a user interface for display comprising the digital pathology image and one or more interactive elements; and
receiving a selection of the one or more tumor regions through interaction with the one or more interactive elements.
49. The method of any of claims 35-48, further comprising:
generating, based at least in part on the tumor immunophenotype of the image and the one or more spatial-distribution metrics, a result that corresponds to an assessment of a medical condition of a subject, including a prognosis for outcomes of the medical condition; and
generating a display including an indication of the assessment of the medical condition of the subject and the prognosis.
50. The method of claim 49, wherein determining the tumor immunophenotype of the image and generating the one or more spatial-distribution metrics use a trained machine-learned model, the trained machine-learned model having been trained using a set of training elements, each of the set of training elements corresponding to another subject having a similar medical condition and for which an outcome of the medical condition is known.

1. A method comprising:
accessing, by a digital pathology image processing system, a digital pathology image that depicts a section of a biological sample, wherein the digital pathology image comprises regions displaying reactivity to a plurality of stains;
subdividing, by the digital pathology image processing system, the digital pathology image into a plurality of tiles;
for each of the tiles, calculating, by the digital pathology image processing system, a local-density measurement of each of a plurality of biological object types;
generating, by the digital pathology image processing system, one or more spatial-distribution metrics for the biological object types in the digital pathology image based at least in part on the calculated local-density measurements; and
determining, by the digital pathology image processing system, a tumor immunophenotype of the digital pathology image based at least in part on the local-density measurements or the one or more spatial-distribution metrics.

2. The method of claim 1, wherein each of the local-density measurements comprises a representation of an absolute or relative quantity, an area, or a density.

3. The method of claim 1, wherein the biological object types comprise tumor cells and immune cells, the tumor immunophenotype comprises:
desert when, for each of the tiles, the local-density measurement of the immune cells is less than an immune-cell-density threshold;
excluded when, for one or more of the tiles, the local-density measurement of the tumor cells is less than a tumor-cell-density threshold and the local-density measurement of the immune cells is greater than or equal to the immune-cell-density threshold; or
inflamed when, for one or more of the tiles, the local-density measurement of the tumor cells is greater than or equal to the tumor-cell-density threshold and the local-density measurement of the immune cells is greater than or equal to the immune-cell-density threshold.

4. The method of claim 1, wherein the one or more spatial-distribution metrics characterize a degree to which a first biological object type is depicted as being interspersed with a second biological object type.

5. The method of claim 1, wherein the one or more spatial-distribution metrics comprise:
a Jaccard index;
a Sørensen index;
a Bhattacharyya coefficient;
a Moran's index;
a Geary's contiguity ratio;
a Morisita-Horn index; or
a metric defined based on a hotspot/coldspot analysis.

6. The method of claim 1, wherein the biological object types comprise tumor cells and immune cells, the tumor immunophenotype comprises:
excluded when, for one or more of the tiles, the one or more spatial-distribution metrics indicate a spatial separation of the tumor cells and the immune cells; or
inflamed when, for one or more of the tiles, the one or more spatial-distribution metrics indicate a co-localization of the tumor cells and the immune cells.

7. The method of claim 1, wherein calculating the local-density measurement of each of the biological object types comprises:
for each of the tiles:
segmenting the tile into a plurality of regions according to the stains, wherein each of the biological object types is reactive to one of the stains;
classifying each of the regions according to reactivity to the stains; and
calculating the local-density measurement of each of the biological object types located within the tile based on a number of the regions of the tile classified with each of the stains.

8. The method of claim 7, wherein each of the regions of the tile is determined based on a stain intensity value of the region, the stain intensity value being based on the reactivity of each of the biological object types to one of the stains.

9. The method of claim 7, wherein the regions of the tiles are determined as tumor-associated regions and non-tumor-associated regions.

10. The method of claim 9, wherein each of the tumor-associated regions and non-tumor-associated regions are determined as immune-cell-associated regions and non-immune-cell-associated regions.

11. The method of claim 1, wherein determining the tumor immunophenotype of the image comprises:
projecting a representation of the digital pathology image into a feature space with axes based on the one or more spatial-distribution metrics; and
determining the tumor immunophenotype of the image based on a position of the digital pathology image within the feature space.

12. The method of claim 11, wherein determining the tumor immunophenotype of the image is further based on a proximity of the position of the digital pathology image within the feature space to a position of one or more other digital pathology image representations with assigned tumor immunophenotypes.

13. The method of claim 1, wherein the biological object types comprise cytokeratin and cytotoxic structures.

14. The method of claim 1, further comprising:
identifying one or more tumor regions in the digital pathology image comprising:
providing a user interface for display comprising the digital pathology image and one or more interactive elements; and
receiving a selection of the one or more tumor regions through interaction with the one or more interactive elements.

15. The method of claim 1, further comprising:
generating, based at least in part on the tumor immunophenotype of the image and the one or more spatial-distribution metrics, a result that corresponds to an assessment of a medical condition of a subject, including a prognosis for outcomes of the medical condition; and
generating a display including an indication of the assessment of the medical condition of the subject and the prognosis.

16. The method of claim 15, wherein determining the tumor immunophenotype of the image and generating the one or more spatial-distribution metrics use a trained machine-learned model, the trained machine-learned model having been trained using a set of training elements, each of the set of training elements corresponding to another subject having a similar medical condition and for which an outcome of the medical condition is known.

17. The method of claim 1, further comprising:
generating, based at least in part on the one or more spatial-distribution metrics, a result that corresponds to a prediction regarding a degree to which a given treatment that modulates immunological response will effectively treat a medical condition of a subject;
determining that the subject is eligible for a clinical trial based on the result; and
generating a display including an indication that the subject is eligible for the clinical trial.

18. A digital pathology image processing system comprising:
one or more data processors; and
a non-transitory computer readable storage medium communicatively coupled to the one or more data processors, and including instructions which, when executed by the one or more data processors, cause the one or more data processors to perform one or more operations comprising:
accessing a digital pathology image that depicts a section of a biological sample, wherein the digital pathology image comprises regions displaying a reaction to a plurality of stains;
subdividing the digital pathology image into a plurality of tiles;
for each of the tiles, calculating a local-density measurement of each of a plurality of biological object types identified within the tile;
generating one or more spatial-distribution metrics for the biological object types in the digital pathology image based at least in part on the calculated local-density measurements; and
determining a tumor immunophenotype of the digital pathology image based at least in part on the local-density measurements and the one or more spatial-distribution metrics.

19. The digital pathology image processing system of claim 18, wherein the biological object types comprise tumor cells and immune cells, the tumor immunophenotype comprises:
desert when, for each of the tiles, the local-density measurement of the immune cells is less than an immune-cell-density threshold;
excluded when, for one or more of the tiles, the local-density measurement of the tumor cells is less than a tumor-cell-density threshold and the local-density measurement of the immune cells is greater than or equal to the immune-cell-density threshold; or
inflamed when, for one or more of the tiles, the local-density measurement of the tumor cells is greater than or equal to the tumor-cell-density threshold and the local-density measurement of the immune cells is greater than or equal to the immune-cell-density threshold.

20. A non-transitory computer-readable medium comprising instructions that, when executed by one or more data processors of one or more computing devices, cause the one or more processors to:
receive a digital pathology image that depicts a section of a biological sample, wherein the digital pathology image comprises regions displaying a reaction to a plurality of stains;
segment the digital pathology image into a plurality of tiles;
for each of the tiles, calculate a local-density measurement of each of a plurality of biological object types identified within the tile;
generate one or more spatial-distribution metrics for the biological object types in the digital pathology image based at least in part on the calculated local-density measurements; and
determine a tumor immunophenotype of the digital pathology image based at least in part on the local-density measurements or the one or more spatial-distribution metrics.
